(19) United States
(12) Patent Application Publication
(10) Pub. No.: US 2010/0231673 A1
(43) Pub. Date: Sep. 16, 2010

(54) IMAGE FORMING METHOD AND APPARATUS

(76) Inventor: Yuhei CHIWATA, Kanagawa-ken (JP)

Correspondence Address: BIRCH STEWART KOLASCH & BIRCH, PO BOX 747, FALLS CHURCH, VA, 22040-0747, US

(21) Appl. No.: 12/722,155

(22) Filed: Mar. 11, 2010

(30) Foreign Application Priority Data
Mar. 12, 2009 (JP) 2009-059944
Mar. 12, 2009 (JP) 2009-059945

(51) Int. Cl. B41J 2/01

(52) U.S. Cl. 347/102

(57) ABSTRACT

The image forming method includes: an image forming step of forming an image on a recording medium by using aqueous ink, the recording medium showing dimensional change of not more than 0.1% with respect to water content of 1 g/m²; a drying step of drying the ink on the recording medium after the image forming step; and a recording medium discharge step of discharging the recording medium after the drying step, wherein the drying is carried out in the drying step so that a difference in water content between an image portion and a non-image portion of the recording medium immediately before the recording medium discharge step is not more than 3.0 g/m².

### BACKGROUND OF THE INVENTION

1. Field of the Invention

The present invention relates to an image forming method and an image forming apparatus, and more particularly to an image forming method and an image forming apparatus whereby the occurrence of cockling and creasing upon fixing can be suppressed.

2. Description of the Related Art

An inkjet recording apparatus forms an image by continuously ejecting and depositing droplets of ink onto a recording medium, and since this kind of apparatus is able to record images of high quality by means of a simple composition, it is widely used both as a domestic printer for individual use and as an office printer and a printing apparatus for commercial use. In the case of commercial use, in particular, there are increasing demands for higher processing speed and higher image quality.

When carrying out inkjet recording onto a paper medium using an aqueous ink, deformation of the paper (curling and cockling) due to interaction between the water in the ink and the paper fibers is a problem. Paper has properties whereby the fibers swell and expand when water is applied to the paper, and the fibers contract when the paper dries. If ink is applied with certain uniformity to the whole surface of a recording medium, curling is liable to occur due to uniform expansion or contraction of the surface of the paper. Curl can be suppressed to some degree by commonly known paper drying technology and correction after printing (applying a reverse tension to the recording medium or applying a weight to the paper from above after output).

Cockling is a more serious problem, and if the recording medium has an image portion on which the ink is deposited and a non-image portion on which no ink is deposited, then the image portion expands greatly due to the effects of the water in the ink, and therefore distortion occurs between the image portion and the non-image portion, and problems such as floating up or the occurrence of indentations in the recording medium have arisen.

Furthermore, in order to ensure sufficient film strength after printing, ink fixing may be carried out by nipping the image portion by means of a heat roller after forming an image with the ink. However, if cockling has occurred in the recording medium when the fixing is carried out, then there is a problem in that creasing occurs due to the squashing of the projecting portions produced by the cockling, when the image is nipped by a heat roller. Once creases have occurred in the recording medium, they remain even after the ink has dried, and therefore print quality is degraded to a very significant degree.

In order to suppress the occurrence of cockling so as to resolve problems of this kind, Japanese Patent Application Publication Nos. 2006-212787, 11-198362 and 2007-160839 disclose technology for suppressing cockling by carrying out forced drying of the recording medium after deposition of ink, and thereby evaporating off the water content. Nevertheless, although the expansion of the image portion can be suppressed by carrying out forced drying as in the related art, contraction occurs in the non-image portion due to the evaporation of the water content originally held in the recording medium, and therefore it has not been possible to suppress cockling adequately.

Moreover, Japanese Patent Application Publication No. 2002-67357 discloses the suppression of cockling by controlling density conversion in such a manner that the amount of ink does not exceed a prescribed value when the density of input image data is converted to ejection ink volumes. However, if an upper limit is placed on the ejection ink volume, the color reproduction range is inevitably narrow, which is an obstacle to achieving high-quality printing.

Furthermore Japanese Patent Application Publication Nos. 2004-58308 and 2005-212371 disclose technology for reducing the expansion and contraction of an image portion and a non-image portion and thereby suppressing cockling by depositing a colorless ink having water as a main component onto a non-image portion by means of an inkjet head. However, a head for ejecting droplets of colorless ink is also required, which is disadvantageous in terms of apparatus costs. Further, since the total amount of water ejected as droplets is increased, the load on the drying step is raised, and there has been a problem in terms of costs, due to increased power consumption, and so on.

### SUMMARY OF THE INVENTION

The present invention has been contrived in view of these circumstances, an object thereof being to provide an image forming method and an image forming apparatus whereby the occurrence of cockling can be suppressed by adjusting the drying state and the contraction rate of the recording medium, and the occurrence of creases formed during fixing can be also suppressed by suppressing the occurrence of cockling.

In order to attain the aforementioned object, the present invention is directed to an image forming method, comprising: an image forming step of forming an image on a recording medium by using aqueous ink, the recording medium showing dimensional change of not more than 0.1% with respect to water content of 1 g/m²; a drying step of drying the ink on the recording medium after the image forming step; and a recording medium discharge step of discharging the recording medium after the drying step, wherein the drying is carried out in the drying step so that a difference in water content between an image portion and a non-image portion of the recording medium immediately before the recording medium discharge step is not more than 3.0 g/m².

According to this aspect of the present invention, since a recording medium that shows little dimensional change with respect to the water content is used as the recording medium, then it is possible to suppress dimensional change even if there is a difference in water content between the image portion and the non-image portion. By making the difference in water content between the image portion and the non-image portion immediately before the recording medium discharge step 3.0 g/m² or less, the difference in the rate of expansion and contraction between the image portion and non-image portion becomes smaller and distortion is reduced, and therefore it is possible to suppress cockling.

Preferably, the image forming method further comprises: after the drying step and before the recording medium discharge step, a fixing step of fixing the ink on the recording medium by applying pressure thereto, wherein the drying is carried out in the drying step so that a difference in water content between the image portion and the non-image portion of the recording medium immediately before the fixing step is not more than 3.0 g/m².

According to this aspect of the present invention, since the cockling has been suppressed immediately before the fixing step, no projecting portions occur in the recording medium, and therefore an image can be formed without the occurrence of creases produced by squashing of the projecting portions.

Preferably, duration from the image forming step until start of the fixing step is not longer than 8 seconds.

According to this aspect of the present invention, by making the duration from the image forming step to the fixing step come within the range described above, it is possible to carry out the drying before the ink solvent permeates into the recording medium, and the amount of ink solvent contained in the recording medium can be suppressed. Consequently, it is possible to restrict the interaction between the recording medium and the ink solvent to a minimum, and hence cockling is reduced more effectively.

Preferably, the image forming step includes ejecting and depositing droplets of the ink onto the recording medium by a single-pass inkjet method using a line head having a width corresponding to a width of the recording medium.

According to this aspect of the present invention, since an image is formed in the image forming step by ink droplet ejection and deposition based on a single-pass inkjet method using the line head having the width corresponding to the width of the recording medium, it is possible to reduce cockling even more effectively. If using another method, such as a shuttle scanning method, the image forming duration generally becomes long and a long duration is required until the recording medium is dried, and therefore permeation of the ink solvent and swelling of the paper fibers progress during this duration and it is difficult to restrict the extent of cockling, in comparison with the single pass method. On the other hand, in the single pass method, it is possible to make the duration from the image formation until the drying relatively short, and therefore permeation of the ink solvent into the recording medium can be suppressed and cockling can be reduced more effectively.

Preferably, an amount of the ink deposited onto the recording medium in the image forming step causes the water content per unit surface area of the recording medium to become not less than 7.0 g/m².

According to this aspect of the present invention, since the difference in the water content between the image portion and the non-image portion of the recording medium immediately before or the recording medium discharge step of the fixing step can be set to 3.0 g/m² or less by means of the drying step, then even under conditions where the water content applied to the recording medium due to the deposition of the ink droplets is 7.0 g/m² or above and cockling is liable to occur, such cockling can be suppressed and particularly beneficial effects are obtained.

Preferably, the method further comprises, before the image forming step, a treatment liquid deposition step of depositing a treatment liquid onto the recording medium, the treatment liquid containing a component which reacts with pigment and resin particles contained in the ink.

According to this aspect of the present invention, since the treatment liquid is deposited on the recording medium, it is possible to form a gap structure in the ink layer by aggregating the pigment and resin particles in the aqueous ink. Consequently, a capillary force acts on the ink solvent and the permeation into the recording medium can be retarded and the ink solvent can be dried in the drying step, thus making it possible to prevent cockling more effectively.

Preferably, duration from the image forming step until the recording medium discharge step is not longer than 10 seconds.

The drying of the recording medium does not progress after the recording medium discharge step since the recording medium is stacked at the recording medium discharge step, and the drying duration of the recording medium substantially terminates at the stacking of the recording medium. According to this aspect of the present invention, by making the duration from the image forming step to the recording medium discharge step come within the range described above, it is possible to suppress cockling more effectively. If the duration from the image forming step to the recording medium discharge step is long, then the ink solvent permeates into the recording medium, and cockling is made to liable to occur. By making the duration from the image forming step to the recording medium discharge step come within 10 seconds, it is possible to restrict the interaction between the recording medium and the ink solvent to a minimum, and hence cockling is reduced more effectively.

Preferably, the drying step is carried out by supplying a drying air flow to the recording medium, the drying air flow having a relative humidity at 23° C. of not less than 40%.

According to this aspect of the present invention, by carrying out the drying using the drying air flow in the drying step, and by setting the relative humidity of the drying air flow to 40% or above at 23° C., it is possible to reduce the difference in the residual amount of water between the image portion and the non-image portion, to 3.0 g/m² or less and cockling can be improved more effectively. If the drying air flow has a relative humidity of less than 40% at 23° C., then drying of the non-image portion progresses and this makes it difficult to make the difference in the residual amount of water between the image portion and the non-image portion equal to or less than 3.0 g/m².

Preferably, the drying air flow has a relative humidity at 23° C. of not more than 90%.

According to this aspect of the present invention, since the relative humidity of the drying air flow is 90% or lower at 23° C., then the drying of the image portion is caused to progress and therefore the difference in the residual amount of water between the image portion and the non-image portion can be reduced to 3.0 g/m² or less, and cockling can be improved more effectively. If the relative humidity of the drying air flow exceeds 90% at 23° C., then drying of the image portion does not progress and this makes it difficult to make the difference in the residual amount of water between the image portion and the non-image portion equal to or less than 3.0 g/m².

Preferably, temperature of the drying air flow is not lower than 50° C.

According to this aspect of the present invention, since the temperature of the drying air flow is 50° C. or higher, then the drying of the image portion is caused to progress and therefore the difference in the residual amount of water between the image portion and the non-image portion can be reduced to 3.0 g/m² or less, and cockling can be improved more effectively.

Preferably, the ink contains a water-soluble organic solvent having an SP value of not more than 27.2 (MPa)^{1/2}.

Since the water in the ink is the reason for damage, such as swelling or shrinkage, which is caused to the recording medium (paper fibers) by the ink, then water-soluble organic solvent having high hydrophilic properties (a high SP value) also interacts with the recording medium and causes damage to the recording medium. According to this aspect of the present invention, by lowering the SP value of the water-soluble organic solvent contained in the ink, the hydrophilic properties of the water-soluble organic solvent are reduced and the interaction with the recording medium is diminished, thus reducing the damage caused and making it possible to improve cockling more effectively.

In order to attain the aforementioned object, the present invention is also directed to an image forming apparatus, comprising: an image forming device which forms an image on a recording medium by using aqueous ink, the recording medium showing dimensional change of not more than 0.1% with respect to water content of 1 g/m²; a drying device which dries the ink on the recording medium on which the image has been formed by the image forming device; a recording medium discharge device which discharges the recording medium which has been dried by the drying device; and a control device which controls the drying device so that a difference in water content between an image portion and a non-image portion of the recording medium when discharged by the recording medium discharge device is not more than 3.0 g/m².

According to the image forming method and apparatus of the present invention, by reducing the difference in water content between the image portion and the non-image portion by means of drying, and by using the recording medium that shows little dimensional change with respect to the water content, it is possible to suppress cockling of the recording medium after drying. Furthermore, it is also possible to suppress the occurrence of fixing creases formed during fixing.

### BRIEF DESCRIPTION OF THE DRAWINGS

FIG. 1 is a general schematic drawing of an inkjet image recording apparatus according to an embodiment of the present invention;

FIGS. 2A to 2C are plan view perspective diagrams showing embodiments of the inkjet head in FIG. 1;

FIG. 3 is a cross-sectional diagram showing the inner composition of an ink chamber unit;

FIG. 4 is a principal block diagram showing the system configuration of the inkjet image recording apparatus in FIG. 1;

FIG. 5 is a diagram illustrating a method of calculating the rate of expansion and contraction of the recording medium;

FIG. 6 is a diagram showing a method of evaluating cockling;

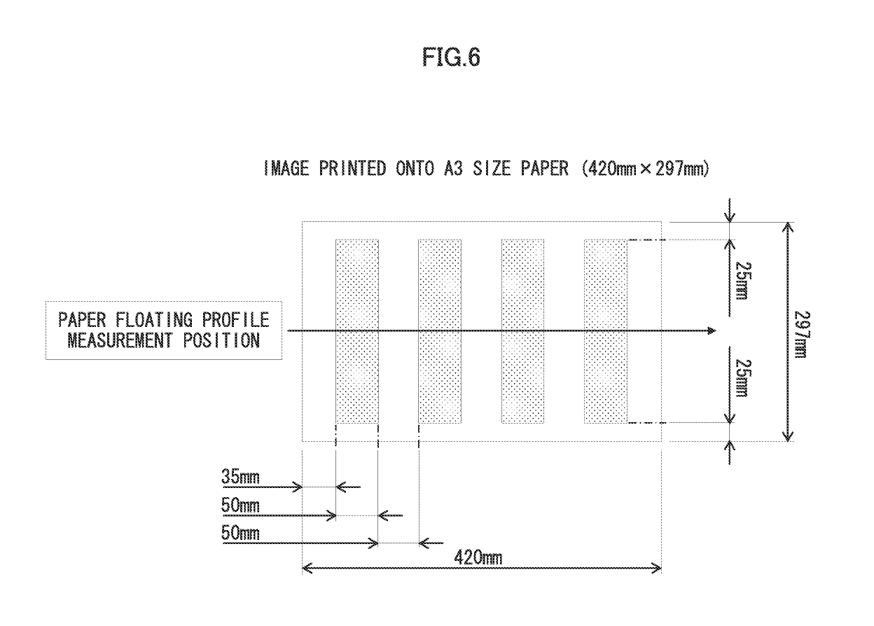

FIG. 7 is a table showing the results of Experiment 1;

FIG. 8 is a table showing the results of Experiment 2;

FIG. 9 is a table showing the results of Experiment 3;

FIG. 10 is a table showing the results of Experiment 4;

FIG. 11 is a table showing the results of Experiment 5;

FIG. 12 is a table showing the results of Experiment 6;

FIG. 13 is a table showing the results of Experiment 7;

FIG. 14 is a table showing the results of Experiment 8;

FIG. 15 is a table showing the results of Experiment 9;

FIG. 16 is a table showing the results of Experiment 10;

FIG. 17 is a table showing the results of Experiment 11; and

FIG. 18 is a table showing the results of Experiment 12.

### DETAILED DESCRIPTION OF THE PREFERRED EMBODIMENTS

### Entire Configuration of Inkjet Recording Apparatus

An inkjet recording apparatus will be described as an apparatus to be used for an image forming method according to an embodiment of the present invention and as an embodiment of an image forming apparatus according to the present invention. However, the present invention is not limited to the inkjet recording apparatus. Moreover, the embodiment below illustrates the drum conveying system as the device which conveys a recording medium, but a belt conveying system can be applied to the device which conveys a recording medium.

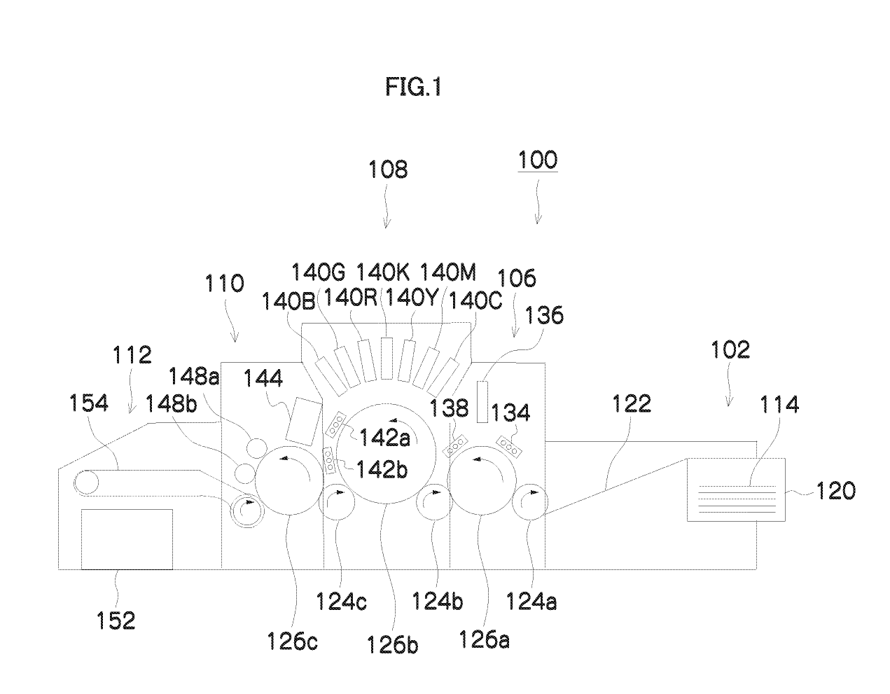

The inkjet recording apparatus 100 is composed as an on-demand printing machine which records images by using cut printing paper. The inkjet recording apparatus 100 includes: a paper supply unit 102, which supplies a recording medium 114; a treatment liquid deposition unit 106, which deposits a prescribed treatment liquid on the recording medium 114; an image formation unit 108, which ejects and deposits droplets of colored inks onto the recording medium 114; a fixing unit 110, which fixes an image formed on the recording medium 114; and a paper discharge unit 112, which conveys and outputs the recording medium 114 on which the image has been formed. In FIG. 1, inkjet heads 140C, 140M, 140Y, 140K, 140R, 140G and 140B in the image formation unit 108 serve as an image forming device, ink drying units 142a and 142b serve as a drying device, and the paper discharge unit 112 serves as a recording medium discharging device.

### <Paper Supply Unit>

The paper supply unit 102 is provided with a paper supply magazine 120, in which cut recording medium 114 is accommodated in a stacked fashion. The paper supply magazine 120 is connected to a feeder board 122, and the recording medium 114 accommodated in the paper supply magazine 120 is sent out sequentially from the top, one sheet at a time, to the feeder board 122. The recording medium 114 which has been conveyed to the feeder board 122 is transferred through a transfer drum 124a to a pressure drum 126a of the treatment liquid deposition unit 106.

### <Treatment Liquid Deposition Unit>

The treatment liquid deposition unit 106 has the pressure drum 126a, and a paper preheating unit 134, a treatment liquid deposition part 136 and a treatment liquid drying unit 138 are arranged in sequence about the outer circumferential surface of the pressure drum 126a.

The pressure drum 126a has a drum shape and rotates by being driven by a motor (not shown). A gripper (not shown) is arranged on the outer circumferential surface of the pressure drum 126a, and the recording medium 114 is conveyed while the leading end thereof is held by the gripper. Furthermore, a plurality of suction holes (not shown) are formed in the outer circumferential surface of the pressure drum 126a, and air is sucked toward the interior of the drum through these suction holes. The recording medium 114 is conveyed while being held by suction through these suction holes.

The paper preheating unit 134 includes a warm air blower, which blows a warm air flow that has been controlled to a prescribed temperature, toward the outer circumferential surface of the pressure drum 126a. When the recording medium 114 conveyed by rotation by the pressure drum 126a passes below the paper preheating unit 134, the warm air flow is blown onto the surface of the recording medium 114, which is thereby preheated.

The treatment liquid deposition part 136 deposits a treatment liquid having a function of causing the coloring material in the ink to aggregate on the surface (image formation surface) of the recording medium 114 that is conveyed by rotation by the pressure drum 126a, to a uniform thickness. The treatment liquid deposition part 136 includes an inkjet head (line head) having the same composition as the respective inkjet heads in the image formation unit 108, and ejects the treatment liquid toward the recording medium 114 that is conveyed by rotation by the pressure drum 126a from the inkjet head, thereby depositing the treatment liquid to a uniform thickness on the surface of the recording medium 114.

The treatment liquid deposition method is not limited to this, and it is also possible, for example, to deposit the treatment liquid by a spray method, a coating method or an application method, or the like.

The treatment liquid drying unit 138 includes a warm air blower, which blows a warm air flow that has been controlled to a prescribed temperature, toward the outer circumferential surface of the pressure drum 126a. When the recording medium 114 conveyed by rotation by the pressure drum 126a passes below the treatment liquid drying unit 138, a warm air flow is blown onto the surface of the recording medium 114, and the treatment liquid deposited on the surface of the recording medium 114 is dried.

According to the treatment liquid deposition unit 106 having the composition described above, the recording medium 114 which has been transferred onto the pressure drum 126a from the feeder board 122 of the paper supply unit 104 through the transfer drum 124a is firstly passed below the paper preheating unit 134 by being conveyed by rotation by the pressure drum 126a. During this passage of the recording medium 114, a warm air flow is blown from the paper preheating unit 134, thereby preheating the recording medium 114. The preheated recording medium 114 then passes below the treatment liquid deposition part 136, and during this passage, the treatment liquid is deposited to a uniform thickness on the surface of the recording medium 114 from the treatment liquid deposition part 136. The recording medium 114 on which the treatment liquid has been deposited is finally passed through the treatment liquid drying unit 138, where a warm air flow is blown from the treatment liquid drying unit 138 during passage, and the treatment liquid deposited on the surface of the recording medium 114 is dried. By this means, an aggregating treatment agent layer is formed on the surface of the recording medium 114.

By depositing the treatment liquid in this way, it is possible to form a gap structure in the ink layer by aggregating the pigment and resin particles contained in the ink which is to be deposited in the subsequent image formation unit. Therefore, a capillary force acts on the ink solvent and the permeation of the ink solvent into the recording medium can be retarded, thus making it possible to prevent cockling.

The recording medium 114 on the surface of which the aggregating treatment agent layer has been formed by the treatment liquid deposition unit 106 is transferred to a pressure drum 126b of the image formation unit 108 through a transfer drum 124b.

Although the inkjet recording apparatus 100 described with reference to FIG. 1 has the treatment liquid deposition unit 106, it is possible to omit the treatment liquid deposition unit 106.

### <Image Formation Unit>

The image formation unit 108 has the pressure drum 126b, and is provided with, arranged in sequence along the outer circumferential surface of the pressure drum 126b: an inkjet head 140C for ejecting cyan-colored (C) ink droplets, an inkjet head 140M for ejecting magenta-colored (M) ink droplets, an inkjet head 140Y for ejecting yellow-colored (Y) ink droplets, an inkjet head 140K for ejecting black-colored (K) ink droplets, an inkjet head 140R for ejecting red-colored (R) ink droplets, an inkjet head 140G for ejecting green-colored (G) ink droplets, an inkjet head 140B for ejecting blue-colored (B) ink droplets, and ink drying units 42a and 42b.

In the present embodiment, there are no particular restrictions on the composition of the inkjet heads, but particularly desirable beneficial effects can be obtained in a single pass method which uses line heads having the width corresponding to the width of the recording medium. In the case of a shuttle scanning method, which carries out interleaved recording, generally the image forming time is long and it takes a long time until the recording medium is dried, and hence the permeation of ink solvent and the swelling of the paper fibers progresses during this time and the degree of cockling becomes worse. In the single pass method, it is possible to make the time from image formation until drying relatively shorter than in the shuttle scanning method, and therefore the permeation of the ink solvent into the paper fibers can be suppressed and cockling can be suppressed more effectively.

The pressure drum 126b is formed in a drum shape similarly to the pressure drum 126a of the treatment liquid deposition unit 106, and is rotated by being driven by a motor (not shown). A gripper (not shown) is arranged on the outer circumferential surface of the pressure drum 126b, and the recording medium 114 is conveyed while the leading end thereof is held by the gripper. Furthermore, a plurality of suction holes (not shown) are formed in the outer circumferential surface of the pressure drum 126b, and air is sucked toward the interior of the drum through these suction holes. The recording medium 114 is conveyed while being held by suction through these suction holes.

The respective inkjet heads 140C, 140M, 140Y, 140K, 140R, 140G and 140B are constituted of line heads corresponding to the width of the recording medium (in the present embodiment, half-Kiku size: 636 mm×469 mm), and the ink ejection surfaces thereof are disposed so as to face the outer circumferential surface of the pressure drum 126b. Each of the nozzle rows formed on the ink ejection surfaces is disposed in a direction perpendicular to the direction of rotation of the pressure drum 126b (namely, the conveyance direction of the recording medium 114).

When the recording medium 114 that is conveyed by rotation by the pressure drum 126b passes below the respective inkjet heads 140C, 140M, 140Y, 140K, 140R, 140G and 140B, ink droplets are ejected and deposited onto the whole area of the recording medium 114 in the breadthways direction (the direction perpendicular to the conveyance direction), and by this means, an image is formed on the whole of the image formation area of the recording medium 114 by one conveyance action (sub-scanning action).

It is acceptable that the water content of aqueous ink deposited on the recording medium is 7.0 g/m² or above. Since cockling can be suppressed even in conditions where cockling is liable to occur, namely, when there is a large difference in water content between the image portion and the non-image portion, for instance, when the water content of the ink is in the aforementioned range or above, then particularly beneficial effects are obtained.

The composition of the inkjet heads 140C, 140M, 140Y, 140K, 140R, 140G and 140B and the composition of the ink supply mechanism are described in detail below.

Each of the ink drying units 142a and 142b is constituted of a warm air blower, which blows a warm air flow that has been controlled to a prescribed temperature, toward the outer circumferential surface of the pressure drum 126b. When the recording medium 114 conveyed by rotation of the pressure drum 126b passes below the ink drying units 142a and 142b, the warm air flow is blown onto the surface of the recording medium 114, and the ink deposited on the surface of the recording medium 114 is dried.

According to the image formation unit 108 having this composition, the recording medium 114 transferred onto the pressure drum 126b from the pressure drum 126a of the treatment liquid deposition unit 106 through the transfer drum 124b is conveyed by rotation of the pressure drum 126a, whereby the recording medium 114 is passed below the inkjet heads 140C, 140M, 140Y, 140K, 140R, 140G and 140B. During this passage of the recording medium 114, droplets of inks of colors are ejected and deposited respectively from the inkjet heads 140C, 140M, 140Y, 140K, 140R, 140G and 140B, thereby forming an image on the surface of the recording medium 114. The recording medium 114 on which the image has been formed passes below the ink drying units 142a and 142b, and during this passage, the warm air flow is blown onto the surface of the recording medium 114 from the ink drying units 142a and 142b, thereby drying the ink droplets deposited on the surface of the recording medium 114.

The drying is desirably carried out in such a manner that the difference in the residual amount of water between the image portion and the non-image portion of the recording medium 114 immediately before the recording medium discharge step becomes not more than 3.0 g/m². By setting this difference in the residual amount of water to be not more than 3.0 g/m², it is possible to reduce the difference in the amount of expansion and contraction between the image portion and the non-image portion of the recording medium 114, and therefore distortion is reduced and cockling of the recording medium 114 can be improved. It is more desirable that the difference in the residual amount of water is made not more than 2.2 g/m².

Furthermore, in a case where there is a fixing step of carrying out image fixing before proceeding to the recording medium discharge step, it is desirable to carry out the drying in such a manner that the difference in the residual amount of water between the image portion and the non-image portion of the recording medium 114 immediately before the fixing step becomes not more than 3.0 g/m². By setting the difference in the residual amount of water to be not more than 3.0 g/m², it is possible to reduce the difference in the amount of expansion and contraction between the image portion and the non-image portion of the recording medium 114, and therefore distortion is reduced and cockling of the recording medium 114 can be improved. Consequently, it is possible to suppress the occurrence of fixing creases. It is more desirable that the difference in the residual amount of water is made not more than 2.2 g/m².

In order to make the difference in the residual amount of water between the image portion and the non-image portion comply with the range described above, it is desirable that the relative humidity (% RH) at 23° C. of the drying air flow blown from the drying units 142a and 142b is set to not less than 40% RH, and more desirably, 50% RH. Since the image portion contains a large amount of water, then the relative humidity in the vicinity of the surface of the recording medium 114 is effectively 100%. However, since the non-image portion does not contain water, then the relative humidity in the vicinity of the surface is low. Hence, if the relative humidity of the drying air flow is low, then this is beneficial for drying the image portion, but since the drying of the non-image portion also progresses, then the difference in the residual amount of water between the image portion and the non-image portion cannot be reduced. By raising the relative humidity of the drying air flow, it is possible to retard the drying of the non-image portion, and therefore the difference in the residual amount of water between the image portion and the non-image portion can be reduced.

The drying air flow is heated in the drier and blown onto the recording medium 114, and therefore the relative humidity of the drying air flow is reduced by the heating process. Although the drying properties of the image portion can be ensured even when the relative humidity at 23° C. is raised to 90% RH, if the relative humidity becomes 95% RH or above, then the amount of drying of the image portion is reduced, the residual amount of water of the image portion is raised, the difference in the residual amount of water between the image portion and the non-image portion becomes greater, and cockling occurs, which is not desirable.

In the present embodiment, the composition is adopted in which the image is formed by using the inks of seven colors of C, M, Y, K, R, G and B; however, the number of combination of ink colors used is not limited to this. It is also possible to add light inks, dark inks, special color inks, or the like, according to requirements. For example, it is possible to adopt a composition which additionally includes heads for ejecting light inks, such as light cyan, light magenta, and the like. Furthermore, it is also possible to use a composition based on the four colors of C, M, Y and K only.

The recording medium 114 on the surface of which the image has been formed by the image formation unit 108 is transferred to a pressure drum 126c of the fixing unit 110 through a transfer drum 124c.

### <Fixing Unit>

The fixing unit 110 has the pressure drum 126c, and an image reading unit 144 and heating rollers 148a and 148b are arranged in sequence from the upstream side in terms of the direction of rotation, about the outer circumferential surface of the pressure drum 126c.

The pressure drum 126c is formed in a drum shape similarly to the pressure drum 126a of the treatment liquid deposition unit 106, and is rotated by being driven by a motor (not shown). A gripper (not shown) is arranged on the outer circumferential surface of the pressure drum 126c, and the recording medium 114 is conveyed while the leading end thereof is held by the gripper.

The image reading unit 144 is constituted of an image sensor (line sensor, or the like) which captures an image of the surface of the recording medium 114 that is conveyed by rotation by the pressure drum 126c. The image read by the image reading unit 144 is used to determine nozzle blockages in each inkjet head in the image formation unit 108 and other ejection defects.

The heating rollers 148a and 148b are controlled to a prescribed temperature and are abutted and pressed against the outer circumferential surface of the pressure drum 126c. When the recording medium 114 conveyed by rotation by the pressure drum 126c is passed by the heating rollers 148a and 148b, the recording medium 114 is heated and pressed between the pressure drum 126c and each of the heating rollers 148a and 148b, and the image formed on the surface of the recording medium 114 is thereby fixed.

Desirably, the heating temperature of the heating rollers 148a and 148b is set in accordance with the glass transition temperature of the polymer particles contained in the treatment liquid and/or the ink.

According to the fixing unit 110 having the composition described above, when the recording medium 114 that has been transferred to the pressure drum 126c from the pressure drum 126b of the image formation unit 108 through the transfer drum 124c is conveyed by rotation by the pressure drum 126c, the recording medium 114 passes below the image reading unit 144 and during this passage, the image formed on the surface of the recording medium 114 is read in, according to requirements. Thereupon, the recording medium 114 is heated and pressed by the heating rollers 148a and 148b, whereby the image formed on the surface of the recording medium 114 is fixed.

It is desirable that the duration from the formation of the image in the image formation unit 108 until the fixing of the image in the fixing unit 110 is not longer than 8 seconds, and more desirably, 5 seconds or less. By making the duration from the image formation unit 108 until the fixing unit 110 eight seconds or less, it is possible to carry out the drying before the ink solvent permeates into the recording medium, and the amount of ink solvent contained in the recording medium can be suppressed. Consequently, it is possible to restrict the interaction between the recording medium and the ink solvent to a minimum, and hence cockling is reduced and creasing upon fixing can be suppressed. The duration from the formation of an image in the image formation unit 108 until the fixing of the image in the fixing unit 110 can be the time from the deposition of ink droplets onto the recording medium 114 by the inkjet head 140 until the starting of the heating and pressing by the heat roller 148b, in FIG. 1 for example. In the present embodiment, by making the difference in the residual amount of water between the image portion and the non-image portion of the recording medium 114 not more than a prescribed value before the fixing, cockling is reduced and the occurrence of fixing creases is suppressed.

The recording medium 114 on which the image has been fixed by the fixing unit 110 is transferred onto a conveyor 154 of the paper discharge unit 112.

Although the inkjet recording apparatus 100 described with reference to FIG. 1 has the fixing unit 110, it is possible to omit the fixing unit 110 and transfer the recording medium 114 dried in the image formation unit 108 directly to the paper discharge unit 112.

### <Paper Discharge Unit>

The paper discharge unit 112 includes the conveyor 154, which conveys the recording medium 114, and a paper discharge magazine 152, which receives the recording medium 114 conveyed by the conveyor 154.

The recording medium 114 on which the image has been fixed by the fixing unit 110 is transferred from the pressure drum 126c of the fixing unit 110 to the conveyor 154, and is conveyed to the paper discharge magazine 152 by the conveyor 154.

The paper discharge magazine 152 receives the recording media 114 conveyed by the conveyor 154, and stores the recording media 114 in a stacked state therein.

It is desirable that the duration from the formation of the image in the image formation unit 108 until the stacking of the recording medium 114 into the paper discharge magazine 152 in the paper discharge unit 112 is not longer than 10 seconds, and more desirably, 7 seconds or less. By making the duration from the image formation unit 108 until the paper discharge unit 112 ten seconds or less, it is possible to suppress cockling. The drying duration of the recording medium 114 terminates at the stacking of the recording medium 114 in the paper discharge magazine 152, because the drying of the recording medium 114 does not progress after the recording medium 114 is stacked in the paper discharge magazine 152. Since the permeating duration of the ink solvent into the recording medium 114 is a few seconds, then by terminating the drying of the recording medium 114 within the specified duration, it is possible to reduce the interaction between the water and the recording medium, and to reduce cockling.

### <Structure of Inkjet Heads>

Next, the structure of the inkjet heads is described. The inkjet heads 140C, 140M, 140Y, 140K, 140R, 140G and 140B for the respective colored inks have the same structure, and a reference numeral 200 is hereinafter designated to any of the inkjet heads (hereinafter also referred to simply as the heads).

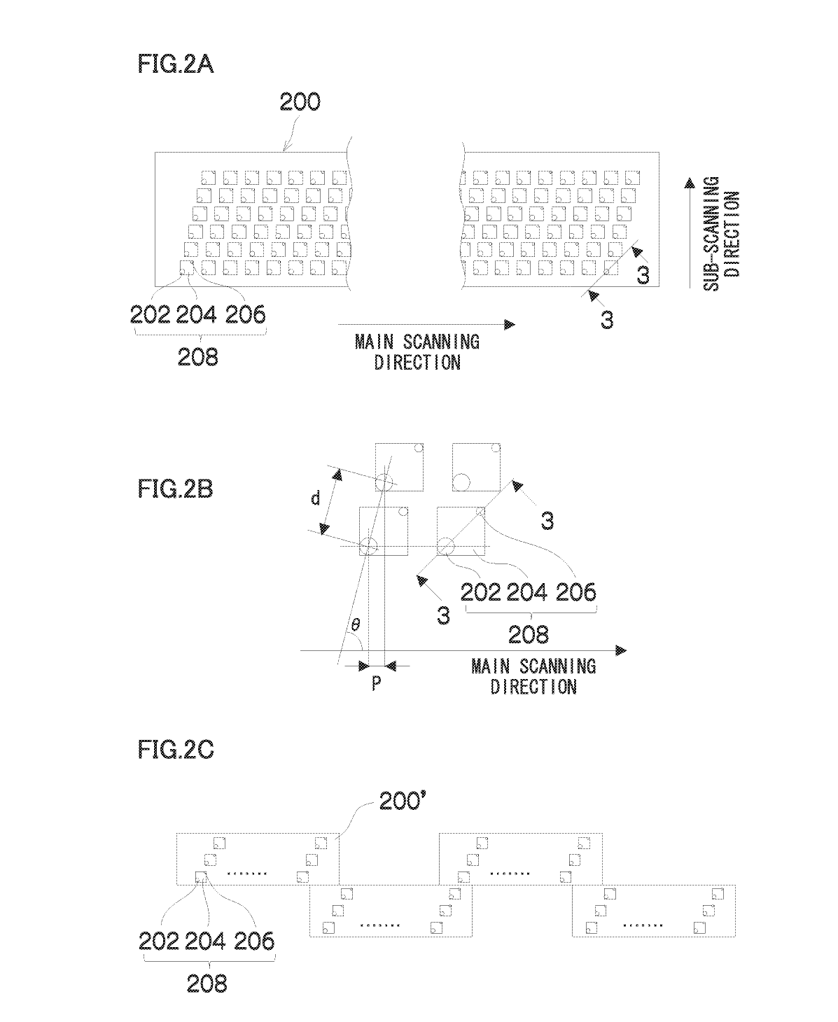

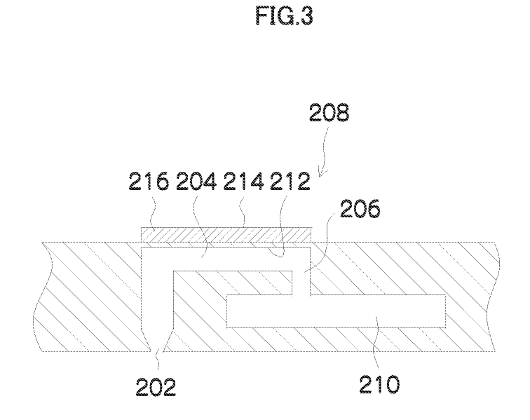

FIG. 2A is a perspective plan view showing an embodiment of the configuration of the head 200, FIG. 2B is an enlarged view of a portion thereof, and FIG. 2C is a perspective plan view showing another embodiment of the configuration of the head 200. FIG. 3 is a cross-sectional view taken along the line 3-3 in FIGS. 2A and 2B, showing the inner structure of an ink chamber unit in the head 200.

The nozzle pitch in the head 200 should be minimized in order to maximize the density of the dots printed on the surface of the recording medium 114. As shown in FIGS. 2A and 2B, the head 200 according to the present embodiment has a structure in which a plurality of ink chamber units (i.e., droplet ejection units serving as recording units) 208, each having a nozzle 202 forming an ink ejection aperture, a pressure chamber 204 corresponding to the nozzle 202, and the like, are disposed two-dimensionally in the form of a staggered matrix, and hence the effective nozzle interval (the projected nozzle pitch) as projected in the lengthwise direction of the head 200 (the main scanning direction: the direction perpendicular to the conveyance direction of the recording medium 114) is reduced and high nozzle density is achieved.

The mode of forming one or more nozzle rows through a length corresponding to the entire width of the recording medium 114 in the main scanning direction substantially perpendicular to the conveyance direction of the recording medium 114 (the sub-scanning direction) is not limited to the embodiment described above. For example, instead of the configuration in FIG. 2A, as shown in FIG. 2C, a line head having nozzle rows of a length corresponding to the entire width of the recording medium 114 can be formed by arranging and combining, in a staggered matrix, short head blocks 200′ having a plurality of nozzles 202 arrayed in a two-dimensional fashion. Furthermore, although not shown in the drawings, it is also possible to compose a line head by arranging short heads in one row.

The planar shape of the pressure chamber 204 provided for each nozzle 202 is substantially a square, and the nozzle 202 and an ink supply port 206 are disposed in both corners on a diagonal line of the square. The shape of the pressure chamber 204 is not limited to that of the present embodiment, and a variety of planar shapes, for example, a polygon such as a rectangle (rhomb, rectangle, etc.), a pentagon and a heptagon, a circle, and an ellipse can be employed.

Each pressure chamber 204 is connected to a common flow channel 210 through the supply port 206. The common flow channel 210 is connected to an ink tank (not shown), which is a base tank for supplying ink, and the ink supplied from the ink tank is delivered through the common flow channel 210 to the pressure chambers 204.

A piezoelectric element 216 provided with an individual electrode 214 is bonded to a diaphragm 212, which forms a face (the upper face in FIG. 3) of the pressure chamber 204 and also serves as a common electrode. When a drive voltage is applied to the individual electrode 214, the piezoelectric element 216 is deformed, the volume of the pressure chamber 204 is thereby changed, and the ink is ejected from the nozzle 202 by the variation in pressure that follows the variation in volume. When the piezoelectric element 216 returns to the original state after the ink has been ejected, the pressure chamber 204 is refilled with new ink from the common flow channel 210 through the supply port 206.

The present embodiment applies the piezoelectric elements 216 as ejection power generation devices to eject the ink from the nozzles 202 arranged in the head 200; however, instead, a thermal system that has heaters within the pressure chambers 204 to eject the ink using the pressure resulting from film boiling by the heat of the heaters can be applied.

As shown in FIG. 2B, the high-density nozzle head according to the present embodiment is achieved by arranging the plurality of ink chamber units 208 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the ink chamber units 208 are arranged at a uniform pitch d in line with a direction forming the angle of θ with respect to the main scanning direction, the pitch P of the nozzles projected so as to align in the main scanning direction is d×cos θ, and hence the nozzles 202 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch. When implementing the present invention, the arrangement structure of the nozzles is not limited to the embodiments shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 114 is moved in the breadthways direction (main scanning direction) of the recording medium 114, thereby performing printing in the breadthways direction, and when one printing action in the breadthways direction has been completed, the recording medium 114 is moved through a prescribed amount in the sub-scanning direction perpendicular to the breadthways direction, printing in the breadthways direction of the recording medium 114 is carried out in the next printing region, and by repeating this sequence, printing is performed over the whole surface of the printing region of the recording medium 114.

### <Description of Control System>

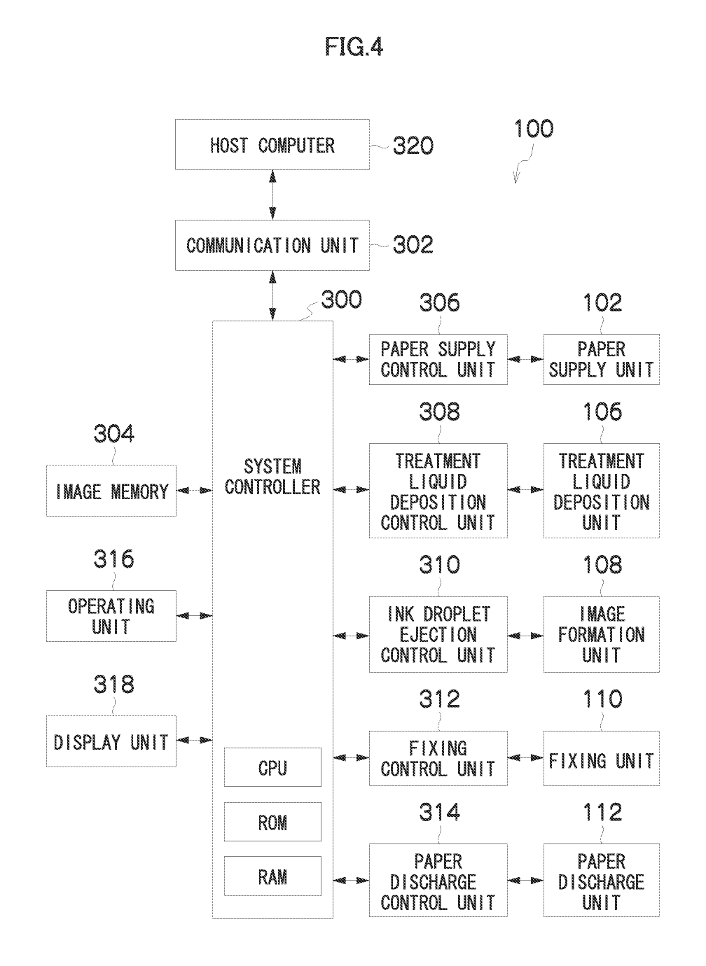

FIG. 4 is a block diagram illustrating the approximate composition of a control system in the inkjet recording apparatus 100 according to the present embodiment.

As illustrated in FIG. 4, the inkjet recording apparatus 100 includes a system controller 300, a communication unit 302, an image memory 304, a paper supply control unit 306, a treatment liquid deposition control unit 308, an ink droplet ejection control unit 310, a fixing control unit 312, a paper discharge control unit 314, an operating unit 316, a display unit 318, and the like.

The system controller 300 functions as a control device which controls the respective units of the inkjet recording apparatus 100, and also functions as a calculation device which carries out various calculation processes. The system controller 300 is constituted of a CPU, ROM, RAM, and the like, and operates in accordance with a prescribed control program. Control programs executed by the system controller 300 and various data required for control purposes are stored in the ROM.

The communication unit 302 has a required communication interface, and transmits and receives data to and from a host computer 320 connected through the communication interface.

The image memory 304 functions as a temporary storage device for various data including image data, and data is read and written though the system controller 300. Image data read in from the host computer 320 through the communication unit 302 is stored in the image memory 304.

The paper supply control unit 306 controls the driving of the respective units which constitute the paper supply unit 102 in accordance with instructions from the system controller 300.

The treatment liquid deposition control unit 308 controls the driving of the respective units which constitute the treatment liquid deposition unit 106 in accordance with instructions from the system controller 300.

The ink droplet ejection control unit 310 controls the driving of the respective units which constitute the image formation unit 108 in accordance with instructions from the system controller 300.

The fixing control unit 312 controls the driving of the respective units which constitute the fixing unit 110 in accordance with instructions from the system controller 300.

The paper discharge control unit 314 controls the driving of the respective units which constitute the paper discharge unit 112 in accordance with instructions from the system controller 300.

The operating unit 316 has a required operation device (for example, operating buttons, a keyboard, a touch panel, or the like), and the operating information input through the operation device is output to the system controller 300. The system controller 300 executes processing of various types in accordance with the operating information input from the operating unit 316.

The display unit 318 has a required display device (for example, an LCD (liquid crystal display) panel, or the like), and the prescribed information is displayed on the display device in accordance with instructions from the system controller 300.

As described above, the image data to be recorded on the recording medium 114 is supplied into the inkjet recording apparatus 100 from the host computer 320 through the communication unit 302, and is stored in the image memory 304. The system controller 300 generates dot data by carrying out prescribed signal processing on the image data stored in the image memory 304, and controlling the driving of the respective ink heads of the image formation unit 108 in accordance with the generated dot data, whereby the image represented by the image data is recorded on the recording medium 114.

Dot data is generally created by subjecting the image data to color conversion processing and half-tone processing. The color conversion processing is processing for converting image data represented by RGB or the like (for example, RGB 8-bit image data) to color data of the respective colors of the inks used by the inkjet recording apparatus 100 (in the present embodiment, color data for K, C, M, Y, R, G and B). The halftone processing is processing for converting the color data of the respective colors generated by the color conversion processing into dot data of the respective colors (in the present embodiment, dot data for K, C, M, Y, R, G and B) by error diffusion processing, or the like.

The system controller 300 generates dot data for the respective colors of C, M, Y, K, R, G and B by carrying out the color conversion processing and the halftone processing of the image data. By controlling the driving of the corresponding ink heads in accordance with the dot data for the respective colors thus generated, an image represented by the image data is recorded on the recording medium 114.

### Recording Medium

There are no particular restrictions on the recording medium used in the present invention, provided that the dimensional change (expansion and contraction characteristics) per 1 g/m² water content is not more than 0.10%, but particularly desirable effects can be obtained with coated printing paper. It is desirable that the dimensional change in the recording medium is not more than 0.08%. A coated printing paper has slow permeation of the ink solvent and therefore drying can be carried out while suppressing the permeation of ink solvent into the recording medium until stacking the recording medium in the paper discharge step. Consequently, it is possible to suppress cockling due to difference in water content occurring in the image portion and the non-image portion, and hence the occurrence of creasing during fixing can be suppressed. If the rate of expansion and contraction of the paper exceeds 0.10%, then even if the difference in water content between the image portion and the non-image portion is not more than 3.0 g/m², it is not possible to reduce the difference in the amount of expansion and contraction between the image portion and the non-image portion, and therefore cockling becomes worse, indentations and projections occur in the recording medium, and creases occur due to the projections being squashed during the fixing process.

Possible examples of support media which can be used appropriately for coated paper are: a base paper manufactured using a Fourdrinier paper machine, cylindrical-wire paper machine, twin-wire paper machine, or the like, from main components of pulp and pigment, the pulp being either a chemical pulp such as LBKP or NBKP, a mechanical pulp, such as GP, PGW, RMP, TMP, CTMP, CMP, CGP, or the like, or wood pulp such as recovered paper pulp, such as DIP, and the main components being mixed with one or more additive of a sizing agent, fixing agent, yield enhancer, cationization agent, paper strength enhancer, or the like, or a base paper provided with a size press layer or anchor coating layer formed using starch, polyvinyl alcohol, or the like, or an art paper, coated paper, or cast coated paper, or the like, formed by providing a coating layer on top of the size press layer or anchor coating layer.

There are no particular restrictions on the weight of the support medium, although generally the weight is approximately 40 g/m² to 300 g/m². The coated paper used in the present embodiment has the coating layer formed on the support medium described above. The coating layer includes a coating composition having a main component of pigment and binder, and at least one layer thereof is formed on the support medium.

For the pigment, it is desirable to use a white pigment. Possible examples of the white pigment are: an inorganic pigment, such as precipitated calcium carbonate, heavy calcium carbonate, magnesium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, hydrated halloysite, magnesium hydroxide, or the like; or an organic pigment, such as a styrene-based plastic pigment, an acrylic plastic pigment, polyethylene, microcapsules, urea resin, melamine resin, or the like.

Possible examples of the binder are: a starch derivative, such as oxidized starch, etherified starch, or phosophoric acid esterized starch; a cellulose derivative, such as carboxymethyl cellulose, hydroxyethyl cellulose, or the like; casein, gelatine, soybean protein, polyvinyl alcohol, or derivatives of same; polyvinyl alcohols having various degrees of saponification or silanol-denatured versions of same, or carboxylates, cationized products, of other derivatives of same; polyvinyl pyrrolidone, maleic anhydride resin, a styrene-butadiene copolymer, a methyl methacrylate-butadiene copolymer, or other conjugated diene copolymer latex; an acrylic polymer latex, such as a polymer or copolymer of acrylate ester and methacrylate ester; a vinyl polymer latex, such as such as an ethylene acetate vinyl copolymer; or a functional group-denatured polymer latex based on these various polymers and a monomer containing a functional group such as a carboxy group; an aqueous adhesive of a heat-curable synthetic resin, such as melamine resin, urea resin, or the like; an acrylate ester such as polymethylmethacrylate; methacrylate ester polymer or copolymer resin, such as methacrylate ester; or a synthetic resin-based adhesive, such as polyurethane resin, unsaturated polyester resin, vinyl chloride-vinyl acetate copolymer, polyvinyl butylal, alkyd resin, or the like.

The combination ratio of the pigment and binder in the coating layer is 3 to 70 parts by weight, and desirably 5 to 50 parts by weight, of binder with respect to 100 parts by weight of pigment. If the combination ratio of the binder with respect to 100 parts by weight of pigment is less than 3 parts by weight, then the coating of the ink receiving layer by the coating composition will have insufficient strength. On the other hand, if the combination ratio is greater than 70 parts by weight, then the absorption of high-boiling-point solvent is slowed dramatically.

Moreover, it is also possible to combine various additives in appropriate fashion in the coating layer, such as: a dye fixing agent, a pigment dispersant, a viscosity raising agent, a fluidity enhancer, an antifoaming agent, a foam suppressant, a separating agent, a foaming agent, a permeating agent, a coloring dye, a coloring pigment, a fluorescent brightener, an ultraviolet light absorber, an antioxidant, an anticorrosive, an antibacterial agent, a waterproofing agent, a wet paper strength enhancer, a dry paper strength enhancer, or the like.

The application amount of the ink receiving layer varies depending on the required luster, the ink absorbing properties and the type of support medium, or the like, and although no general figure can be stated, it is normally 1 g/m² or greater. Furthermore, the ink receiving layer can also be applied by dividing a certain uniform application amount into two application steps. If application is divided into two steps in this way, then the luster is raised in comparison with a case where the same application amount is applied in one step.

The application of the coating layer can be carried out using one of various types of apparatus, such as a blade coater, roll coater, air knife coater, bar coater, rod blade coater, curtain coater, short dowel coater, size press, or the like, in on-machine or off-machine mode.

Furthermore, after application of the coating layer, it is also possible to carry out a smoothing and finishing process on the ink receiving layer by using a calender apparatus, such as a machine calender, a TG calender, a soft calender, or the like.

The number of coating layers can be determined appropriately in accordance with requirements. The coating paper can be classified, by the application amount of the coating layer, into an art paper, high-quality coated paper, medium-quality coated paper, high-quality lightweight coated paper, medium-quality lightweight coated paper, or light-coated printing paper; the application amount of the coating layer is around 40 g/m² on both surfaces in the case of art paper, around 20 g/m² on both surfaces in the case of high-quality coated paper or medium-quality coated paper, around 15 g/m² on both surfaces in the case of high-quality lightweight coated paper or medium-quality lightweight coated paper, and 12 g/m² or less on both surfaces in the case of a light-coated printing paper. Each of the classifications can be further divided by the paper glossiness into gloss paper and matt paper. An example of a gloss art paper is Tokubishi Art (made by Mitsubishi Paper Mills), and an example of a matt art paper is Saten Kanefuji (made by Oji Paper). Examples of gross high-quality coated paper are OK Top Coat (made by Oji Paper), Aurora Coat (made by Nippon Paper Group), Recycle Coat T-6 (made by Nippon Paper Group); examples of matt high-quality coated paper are Urite (made by Nippon Paper Group), New V Matt (made by Mitsubishi Paper Mills), Recycle Matt T-6 (made by Nippon Paper Group). Examples of light-coated printing paper are Aurora L (made by Nippon Paper Group) and Kinmari Hi-L (made by Hokuetsu Paper Mills), or the like.

### Aqueous Ink

The aqueous ink used in the embodiment of the present invention will be described below in greater detail. The aqueous ink contains at least a resin dispersant (A), a pigment (B) that is dispersed by the resin dispersant (A), self-dispersible polymer particles (C), and an aqueous liquid medium (D).

### <Resin Dispersant (A)>

The resin dispersant (A) is used as a dispersant for the pigment (B) in the aqueous liquid medium (D) and may be any appropriate resin, provided that it can disperse the pigment (B). The preferred structure of the resin dispersant (A) includes a hydrophobic structural unit (a) and a hydrophilic structural unit (b). If necessary, the resin dispersant (A) can also include a structural unit (c) that is different from the hydrophobic structural unit (a) and hydrophilic structural unit (b).

As for the compounding ratio of the hydrophobic structural unit (a) and hydrophilic structural unit (b), it is preferred that the hydrophobic structural unit (a) takes more than 80 wt %, desirably 85 wt % or more of the total weight of the resin dispersant (A). Thus, the compounding ratio of the hydrophilic structural unit (b) has to be not more than 15 wt %. Where the compounding ratio of the hydrophilic structural unit (b) is more than 15 wt %, the amount of component that is independently dissolved in the aqueous liquid medium (D), without participating in the dispersion of the pigment, increases, thereby causing degradation of performance such as dispersivity of the pigment (B) and worsening the ejection ability of ink for inkjet recording.

### <Pigment (B)>

In the embodiment of the present invention, the pigment (B) is a general term for color substances (including white color when the pigment is inorganic) that are practically insoluble in water and organic solvents, as described in Kagaku Daijiten (third edition), published on Apr. 1, 1994, (ed. by Michinori Oki et al.), p. 518, and organic pigments and inorganic pigments can be used in the embodiment of the present invention.

Further, “the pigment (B) dispersed by the resin dispersant (A)” in the description of the embodiment of the present invention means a pigment that is dispersed and held by the resin dispersant (A) and is desirably used as a pigment that is dispersed and held by the resin dispersant (A) in the aqueous liquid medium (D). An additional dispersant may be optionally contained in the aqueous liquid medium (D).

The pigment (B) dispersed by the resin dispersant (A) used in the embodiment of the present invention is not particularly limited, provided that it is a pigment that is dispersed and held by the resin dispersant (A). From the standpoint of pigment dispersion stability and ejection stability, microcapsulated pigments produced by a phase transition method are more preferred from among the aforementioned pigments.

A microcapsulated pigment represents a preferred example of the pigment (B) employed in the embodiment of the present invention. The microcapsulated pigment as referred to herein is a pigment coated by the resin dispersant (A).

The resin of the microcapsulated pigment has to use the resin dispersant (A), but it is preferred that a polymer compound having self-dispersibility or solubility in water and also having an anionic (acidic) group be used in a resin other than the resin dispersant (A).

The pigments may be used individually or in combinations obtained by selecting a plurality of pigments in each of the above-described groups or a plurality of pigments from different groups.

From the standpoint of dispersion stability and concentration of the aqueous ink, the content ratio of the pigment (B) in the aqueous ink used in the embodiment of the present invention is desirably 1 wt % to 10 wt %, more desirably 2 wt % to 8 wt %, and even more desirably 2 wt % to 6 wt %.

### <Ratio of Pigment (B) and Resin Dispersant (A)>

The weight ratio of the pigment (B) and resin dispersant (A) is desirably 100:25 to 100:140, more desirably 100:25 to 100:50. When the resin dispersant is present at a ratio not lower than 100:25, the dispersion stability and abrasion resistance tend to improve, and where the resin dispersant is present at a ratio of 100:140 or less, the dispersion stability tends to improve.

### <Self-Dispersible Polymer Particles (C)>

The aqueous ink used in the embodiment of the present invention includes self-dispersible polymer particles of at least one kind. Self-dispersible polymer particles as referred to herein mean particles of a water-insoluble polymer containing no free emulsifying agent, this water-insoluble polymer being capable of assuming a dispersion state in an aqueous medium under the effect of functional groups (especially acidic groups or salt thereof) of the resin itself, without the presence of another surfactant.

The dispersion state as referred to herein includes both an emulsion state (emulsion) in which the water-insoluble polymer is dispersed in a liquid state in the aqueous medium and a dispersion state (suspension) in which the water-insoluble polymer is dispersed in a solid state in the aqueous medium.

The self-dispersible polymer particles used in the embodiment of the present invention can be advantageously contained in an aqueous ink composition, and the particles of one kind may be used individually, or particles of two or more kinds may be used together.

### <Aqueous Liquid Medium (D)>

In the aqueous ink of the inkjet recording system, the aqueous liquid medium (D) represents a mixture of water and a water-soluble organic solvent. The water-soluble organic solvent (hereinafter also referred to as “water-soluble organic solvent medium”) is used as a drying preventing agent, wetting agent, and penetrating agent.

The ink composition uses the water-soluble solvent for the purpose of a drying prevention agent, wetting agent or permeation promoting agent. In particular, in the case of the aqueous ink composition used in the inkjet recording method, it is desirable to use an organic water-soluble solvent, for the purpose of a drying prevention agent, wetting agent or permeation promoting agent.

A drying prevention agent or wetting agent is used with a view to preventing blockages caused by drying of the inkjet ink in the ink ejection ports of the nozzles, and it is desirable to use an organic water-soluble solvent having a lower vapor pressure than water as the drying prevention agent or wetting agent.

In the present invention, it is desirable to use a water-soluble organic solvent having a low SP value in order to reduce the damage caused to the paper fibers by the solvent in the ink, and use of a water-soluble organic solvent having an SP value of 27.2 (MPa)^{1/2} or lower is preferable and use of a water-soluble organic solvent having an SP value of 20.5 (MPa)^{1/2} or lower is even more desirable. By using an organic solvent having a low SP value, permeation into the recording medium is suppressed, damage such as swelling or shrinkage can be reduced, and cockling can be improved. The SP value (solubility parameter) of the water-soluble solvent described here is a value expressed as the square root of the molecular aggregation energy, and this value can be calculated by the method described by R. F. Fedors in Polymer Engineering and Science, 14, p. 147 (1974). The SP value is indicated in the unit of (MPa)^{1/2} and the value at 25° C.

It is desirable that the aqueous liquid medium (D) contains a compound expressed by the following structural formula (I):

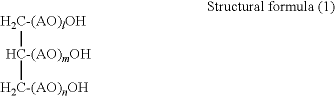

Here, the “water-soluble organic solvent” and the “compound expressed by the structural formula (I)” may be the same substance or different substances.

In the structural formula (I), l, m and n are respective and independent natural numbers, and 1+m+n=3 to 15. In the foregoing, desirably, 1+m+n is 3 to 12, and more desirably, 3 to 10. In the structural formula (I), AO represents ethylene oxy and/or propylene oxy, and of these, a propylene oxy group is desirable. The AO in (AO)ₗ, (AO)ₘ and (AO)ₙ may be respectively the same or different.

Examples of compounds having the above-described structure and an SP value of 27.5 (MPa)^{1/2} or lower are listed as follows, together with their SP values (MPa)^{1/2} in parentheses.

diethylene glycol monoethyl ether (22.4)
diethylene glycol monobutyl ether (21.5)
triethylene glycol monobutyl ether (21.1)
dipropylene glycol monomethyl ether (21.3)
dipropylene glycol (27.2)

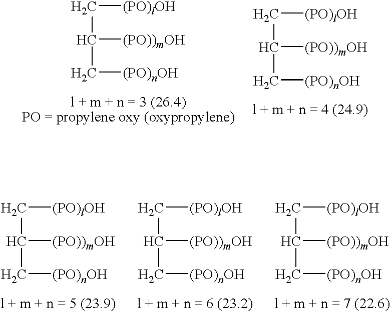

nC₄H₉O(AO)₄—H (AO=EO or PO, ratio 1:1) (20.1) EO=ethylene oxy (oxyethylene)
nC₄H₉O(AO)₁₀—H (as above) (18.8)
HO(A′O)₄₀—H (A′O=EO or PO, ratio EO:PO=1:3) (18.7)
HO(A″O)₅₅—H (A″O=EO or PO, ratio EO:PO=5:6) (18.8)

### HO(PO)₃—H (24.7)

### HO(PO)₇—H (21.2)

1,2 hexanediol (27.4)

The ratio (content) of the compound expressed by the structural formula (I) in the water-soluble solvent is desirably 10% or greater, more desirably, 30% or greater and even more desirably, 50% or greater. No problems occur, even if a high value is adopted.

The water-soluble organic solvents may be used individually or in mixtures of two or more thereof.

From the standpoint of ensuring stability and ejection characteristic, the content ratio of the water-soluble organic solvent in the ink is desirably not less than 1 wt % and not more than 60 wt %, more desirably not less than 5 wt % and not more than 40 wt %, yet more desirably not less than 10 wt % and not more than 30 wt %.

The amount of water added to the ink is not particularly limited; however, from the standpoint of ensuring stability and ejection characteristic, it is desirably not less than 10 wt % and not more than 99 wt %, more desirably not less than 30 wt % and not more than 80 wt %, and yet more desirably not less than 50 wt % and not more than 70 wt %.

### <Surfactant>

It is preferred that a surfactant is added to the aqueous ink used in the embodiment of the present invention. A compound having a structure having a combination of a hydrophilic portion and a hydrophobic portion in a molecule can be effectively used as the surfactant, and anionic surfactants, cationic surfactants, amphoteric surfactants, and nonionic surfactants can be used. Furthermore, the above-described polymer substance (polymer dispersant) can be also used as the surfactant.

### <Other Components>

The aqueous ink used in the embodiment of the present invention may also include other additives. Examples of other additives include such well-known additives as an ultraviolet absorbent, a fading preventing agent, an antimold agent, a pH adjusting agent, an antirust agent, an antioxidant, an emulsion stabilizer, a preservative, an antifoaming agent, a viscosity adjusting agent, a dispersion stabilizer, and a chelating agent.

### Treatment Liquid

The aqueous treatment liquid used in the embodiment of the present invention contains at least one solidifying agent which solidifies the components in the aqueous ink. The solidifying agent used in the present embodiment is able to solidify (aggregate) the aqueous ink by making contact with the aqueous ink on the paper. For example, by applying the aqueous treatment liquid, droplets of the aqueous ink are deposited in a state where the solidifying agent is present on the paper and they make contact with the solidifying agent, whereby the component in the aqueous ink can be made to aggregate and solidify on the paper.

Since it is desirable to be able to solidify (aggregate) the aqueous ink, desirably, the treatment liquid is a material that dissolves readily in the aqueous ink upon making contact with the aqueous ink and from this viewpoint, a polyvalent metallic salt having high water solubility is more desirable and an acidic material having high water solubility is also desirable. Furthermore, from the viewpoint of solidifying the whole of the ink by reacting with the aqueous ink, a bivalent or higher-valence acidic material is especially desirable. Moreover, for the solidifying agent, it is also possible to use a cationic compound.

Here, the aggregating reaction of the aqueous ink may be achieved by reducing the dispersion stability of the particles (coloring material (for example, pigment), resin particles, etc.) which are dispersed in the aqueous ink, and causing the overall viscosity of the ink to rise. For example, the surface potential of the particles contained in the ink, such as pigment and resin particles, which are held in stable dispersion by a weakly acidic functional group, such as a carboxyl group, is lowered by reacting with an acidic material having a lower pKa, thereby reducing the dispersion stability. Hence, the acidic material forming a solidifying agent which is contained in the aqueous treatment liquid is desirably one having a low pKa, high solubility and valence of 2 or above, and more desirably, it is a bivalent or trivalent acidic material having a high buffering capacity in a lower pH region than the pKa of the functional group (for example, carboxyl group) that stabilizes the dispersion of the particles contained in the ink.

The content ratio of the solidifying agent which solidifies the aqueous ink in the aqueous treatment liquid is desirably, 1 wt % to 40 wt %, more desirably, 5 wt % to 30 wt % and even more desirably 10 wt % to 25 wt %.

The aqueous treatment liquid used in the embodiment of the present invention can generally also include, in addition to the solidifying agent, a water-soluble organic solvent, and furthermore, similarly to the aqueous ink, may also contain other additives of various kinds. The organic solvent described above may be used independently, or a combination of two or more types of organic solvent may be used. Furthermore, desirably, these organic solvents are contained in a range of 1 wt % to 50 wt % in the treatment liquid.

### EXAMPLES

Below, the characteristic features of the present invention are described more specifically on the basis of practical examples; however, the scope of the present invention should not be interpreted as being limited by the specific examples described below.

### <Preparation of Treatment Liquid>

A treatment liquid was prepared by mixing together the following materials:

| | |
|---|---|
| Malonic acid: | 10 wt % |
| Diethylene glycol monoethyl ether: | 20 wt % |
| Olfine E1010 (made by Nissin Kagaku Kogyo): | 1 wt % |
| Deionized water: | Reminder |

### <Preparation of Ink>

An ink was prepared by mixing together the following materials:

| | |
|---|---|
| Pigment 1: | 4 wt % |
| Dispersant polymer 1: | 2 wt % |
| Resin emulsion: | 8 wt % |
| Water-soluble organic solvent: | 15 wt % |
| Olfine E1010: | 1 wt % |
| Deionized water | Remainder |

The details of the respective components described above were as follows.

Pigment 1: Cromophtal Jet Magenta DMQ (PR-122) (made by Ciba Specialty Chemicals Inc.)

Dispersant polymer 1: benzyl methacrylate/methyl methacrylate/methacrylic acid, 60/30/10 (weight ratio)

Resin emulsion: methyl methacrylate/phenoxyethyl acrylate/acrylic acid, 66/29/5 (weight ratio), the glass transition point=65° C.

As the water-soluble organic solvent, the solvents having different SP values were used in the inks 1 to 7, respectively, as shown in Table 1 below.

TABLE 1

| | | SP value of water-soluble |
|---|---|---|
| Ink | | organic solvent (calculated |
| number | Water-soluble organic solvent | by Fedors method) (MPa)^{1/2} |
| Ink 1 | Tripropylene glycol monomethyl | 20.43 |
| | ether | |
| Ink 2 | Diethylene glycol monoethyl ether | 22.38 |
| Ink 3 | Tripropylene glycol | 24.67 |
| Ink 4 | Dipropylene glycol | 27.14 |
| Ink 5 | Triethylene glycol | 27.79 |
| Ink 6 | Diethylene glycol | 30.62 |
| Ink 7 | Glycerin | 33.52 |

### <Recording Medium>

The recording media used are shown in Table 2 below.

TABLE 2

| Paper | | | Weight | Expansion/ |
|---|---|---|---|---|
| number | Name and maker | | (g/m²) | contraction rate (%) |
| Paper 1 | Saten Kanefuji N | Oji Paper | 127.9 | 0.04 |
| Paper 2 | SA Kanefuji | Oji Paper | 127.9 | 0.04 |
| Paper 3 | Aurora Coat | Nippon Paper Group | 127.9 | 0.05 |
| Paper 4 | Tokubishi Art | Mitsubishi Paper | 104.7 | 0.06 |
| | Double-Side N | Mills | | |
| Paper 5 | OK Top Coat Plus | Oji Paper | 104.7 | 0.08 |
| Paper 6 | Urite | Nippon Paper Group | 104.7 | 0.10 |
| Paper 7 | New Age | Oji Paper | 104.7 | 0.12 |
| Paper 8 | OK top coat plus | Oji Paper | 73.3 | 0.14 |
| Paper 9 | Urite | Nippon Paper Group | 81.4 | 0.15 |
| Paper 10 | Shiraoi | Nippon Paper Group | 81.4 | 0.20 |

### <Method of Measuring Paper Expansion and Contraction Rate>

The expansion and contraction rates of the respective papers shown in Table 2 above were measured by the following method.

1. The paper was cut to a size of 15 cm×4 cm, with the paper weave (the orientation of the paper fibers) aligned in the breadthways direction, in such a manner that the direction in which the paper was liable to expand and contract was aligned with the lengthwise direction.

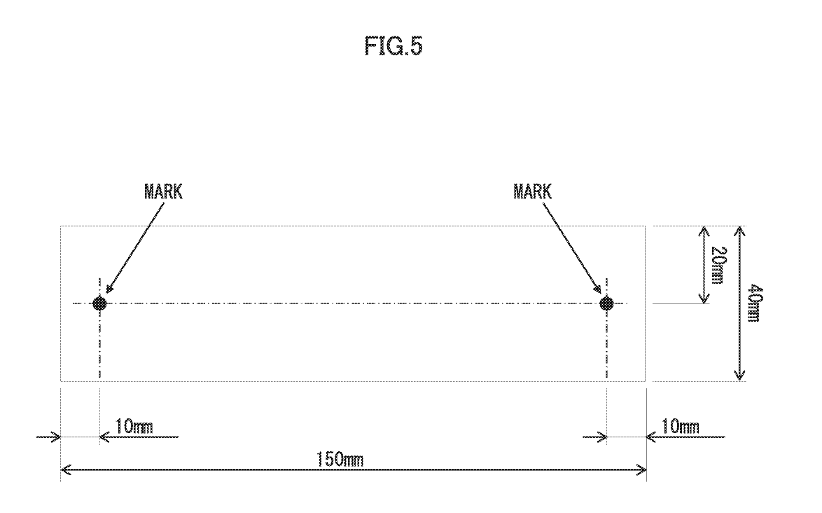

2. As shown in FIG. 5, black circles having a diameter of approximately 2 mm were inscribed with a felt-tip pen on the paper at either end position thereof, to form expansion length measurement marks.

3. The paper conditions were adjusted for one day in an environment of 23° C. and 50% RH.

4. The distance between the two pen marks was measured using a microscopic length measurement system (the measurement value was taken to be X1). The paper was held between two transparent glass plates (which were bigger than the size of the paper) and placed on a microscopic length measurement stage. For the microscopic length measurement system, a NEXIV VMR (made by Nikon), or the like, equipped with an image capturing and recognition system and an X-Y stage was used.

5. Pure water was applied at an application volume of 1 g/m² onto the whole surface of the paper, using a paper conveyance stage and inkjet head. Here, an application roller, or the like, might be used to apply the pure water.

6. After applying the pure water, the paper was immediately held between two sheets of glass (in order to prevent evaporation of water).

7. The paper held between the glass plates was placed on the stage of the microscopic length measurement system and the distance between the marks is measured (the measurement value was taken to be X2).

8. The expansion and contraction rate of the paper was calculated by (X2−X1)/X1.

### <Method of Forming Image>

An image was formed by using the inkjet recording apparatus shown in FIG. 1, under the following conditions:

Paper conveyance speed: 500 mm/s;

Deposition of treatment liquid: uniformly deposing the treatment liquid to the image surface at a deposition volume of 1.5 g/m² by an application roller;

Drying of treatment liquid: drying the deposited treatment liquid for one second by a rear surface heater at 40° C. and heated air flow at 70° C.;

Ink droplet deposition: forming a prescribed image at resolution of 1200 dpi and droplet ejection volume of 4.5 picoliters;

Ink drying: drying the deposited ink by rear surface heating of recording medium on the pressure drum 126c at prescribed pressure drum temperature, and by warm air flow of prescribed temperature and prescribed relative humidity, shown in the following Table 3; and

Ink fixing: fixing the dried ink onto the recording medium by means of a heat roller (a hollow aluminum roller of 40 mm diameter covered with silicone rubber of a prescribed rubber hardness and thickness), at a roller temperature of 70° C., a roller nip pressure of 0.30 MPa, and a nip passage time of 20 ms.

TABLE 3

| | Drying air flow | Relative humidity of | Pressure drum |
|---|---|---|---|
| Drying | temperature | drying air flow at 23° C. | temperature |
| conditions | (° C.) | (% RH) | (° C.) |
| Condition 1 | 40 | 50 | 40 |
| Condition 2 | 45 | 50 | 45 |
| Condition 3 | 50 | 50 | 50 |
| Condition 4 | 55 | 50 | 55 |
| Condition 5 | 60 | 50 | 60 |
| Condition 6 | 70 | 50 | 70 |
| Condition 7 | 80 | 50 | 80 |
| Condition 8 | 50 | 50 | 61 |
| Condition 9 | 50 | 50 | 58 |
| Condition 10 | 50 | 50 | 54 |
| Condition 11 | 50 | 50 | 48 |
| Condition 12 | 50 | 50 | 46 |
| Condition 13 | 50 | 50 | 44 |
| Condition 14 | 50 | 20 | 41 |
| Condition 15 | 50 | 30 | 43 |
| Condition 16 | 50 | 40 | 45 |
| Condition 17 | 50 | 60 | 57 |
| Condition 18 | 50 | 70 | 53 |
| Condition 19 | 50 | 80 | 56 |
| Condition 20 | 50 | 90 | 60 |
| Condition 21 | 50 | 95 | 65 |
| Condition 22 | 40 | 50 | 44 |
| Condition 23 | 45 | 50 | 49 |
| Condition 24 | 50 | 50 | 54 |
| Condition 25 | 55 | 50 | 59 |
| Condition 26 | 60 | 50 | 64 |
| Condition 27 | 70 | 50 | 74 |
| Condition 28 | 80 | 50 | 84 |
| Condition 29 | 50 | 50 | 65 |
| Condition 30 | 50 | 50 | 62 |
| Condition 31 | 50 | 50 | 58 |
| Condition 32 | 50 | 50 | 52 |
| Condition 33 | 50 | 50 | 50 |
| Condition 34 | 50 | 50 | 48 |
| Condition 35 | 50 | 20 | 45 |
| Condition 36 | 50 | 30 | 47 |
| Condition 37 | 50 | 40 | 49 |
| Condition 38 | 50 | 60 | 61 |
| Condition 39 | 50 | 70 | 57 |
| Condition 40 | 50 | 80 | 60 |
| Condition 41 | 50 | 90 | 64 |
| Condition 42 | 50 | 95 | 69 |

The water content of the printing paper was measured by extracting a paper measurement portion of 3 cm×3 cm size, and using a moisture meter CA-200 (manufactured by Mitsubishi Chemical Analytech). The water content (grams) thus measured was taken and divided by the extracted surface area to give the water content per unit surface area (g/m2). Furthermore, the amount of residual water was found by subtracting the water content held in the paper before printing from the water content remaining after drying the deposited ink droplets. The water content held in the paper was separately measured with unused paper.

### <Evaluation of Cockling>

Cockling was evaluated by the following method.

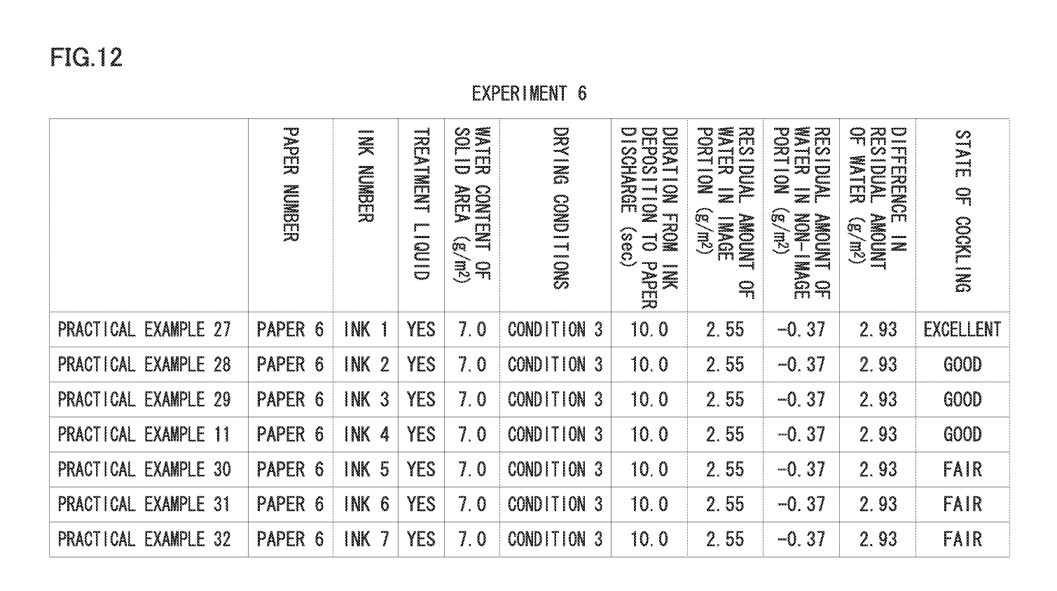

100 sheets of a prescribed image pattern were printed continuously under prescribed printing conditions, using paper of A3 size. The 100 printed samples were left for one day in a stacked state, under conditions of 23° C. and 50% RH. After being left for one day, one sample was extracted from the stack of 100 sheets, and was left for one day on a flat table, under conditions of 23° C. and 50% RH. The paper floating profile measurement position shown in FIG. 12 was measured using a displacement meter having measurement accuracy within 0.01 mm In the present examples, a three-dimensional meter Quick Vision Hybrid Type 1 (made by Mitsutoyo) was used. In order to exclude floating up of the end portion of the paper, an area 5 mm from each of the four edges of the paper was pressed down with a glass plate on the measurement stage during measurement. The gradient was corrected in respect of the paper floating profile thus measured, and the height difference in the paper floating profile after the gradient correction was evaluated according to the following criteria:

Excellent: not more than 0.10 mm;

Good: more than 0.10 mm and not more than 0.20 mm;

Fair: more than 0.20 mm and not more than 0.30 mm; and

Poor: more than 0.30 mm.

### <Evaluation of Fixing Creases>

Fixing creases were evaluated by the following method.

Printing was carried out under the prescribed printing conditions using paper of A3 size. The print sample was visually observed and the degree of creasing was evaluated on the basis of the following criteria:

Excellent: no creases were observed at all;

Good: slight creasing was recognized when sample was observed with careful attention, but of a barely discernable level;

Fair: slight creasing occurred, but of a tolerable level in practical terms; and

Poor: severe creasing occurred; not tolerable.

### <Results>

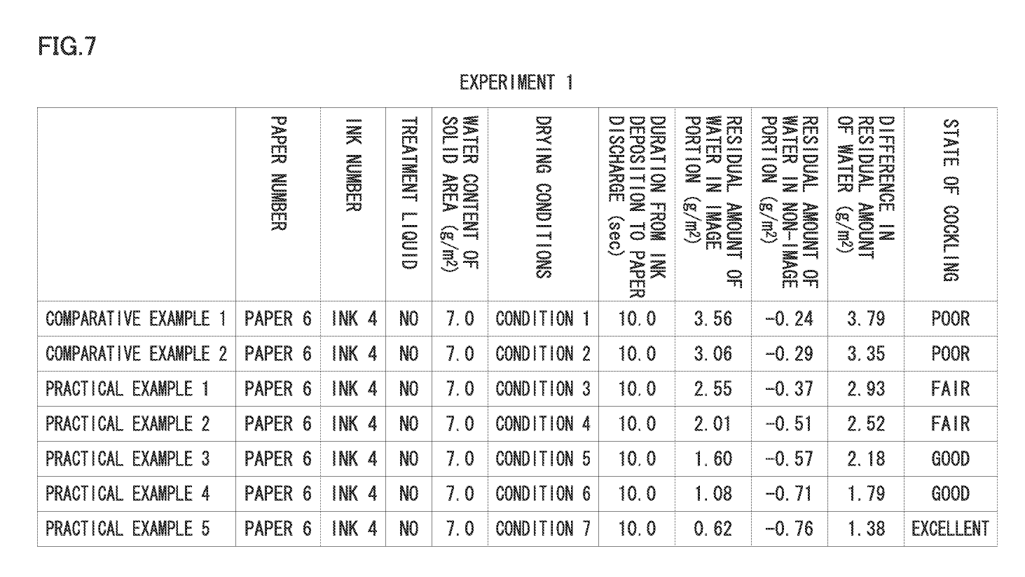

Cockling was evaluated while changing the residual amount of water (Experiment 1), the recording medium (Experiment 2), the presence/absence of treatment liquid (Experiment 3), the time from image formation until fixing (Experiment 4), the relative humidity of the drying air flow (Experiment 5), or the SP value of the water-soluble organic solvent (Experiment 6). The results are shown in FIGS. 7 to 12, respectively.

As shown in FIG. 7, in Experiment 1 where the residual amount of water was changed, it was possible to form an image in which cockling on the recording medium was suppressed by setting the difference in the residual amount of water between the image portion and the non-image portion to be not more than 3.0 g/m² in each of Practical Examples 1 to 5. Furthermore, as the difference in the residual amount of water decreased, it became more possible to suppress cockling. Conversely, in Comparative Examples 1 and 2 where the difference in the residual amount of water exceeded 3.0 g/m², cockling could not be suppressed.

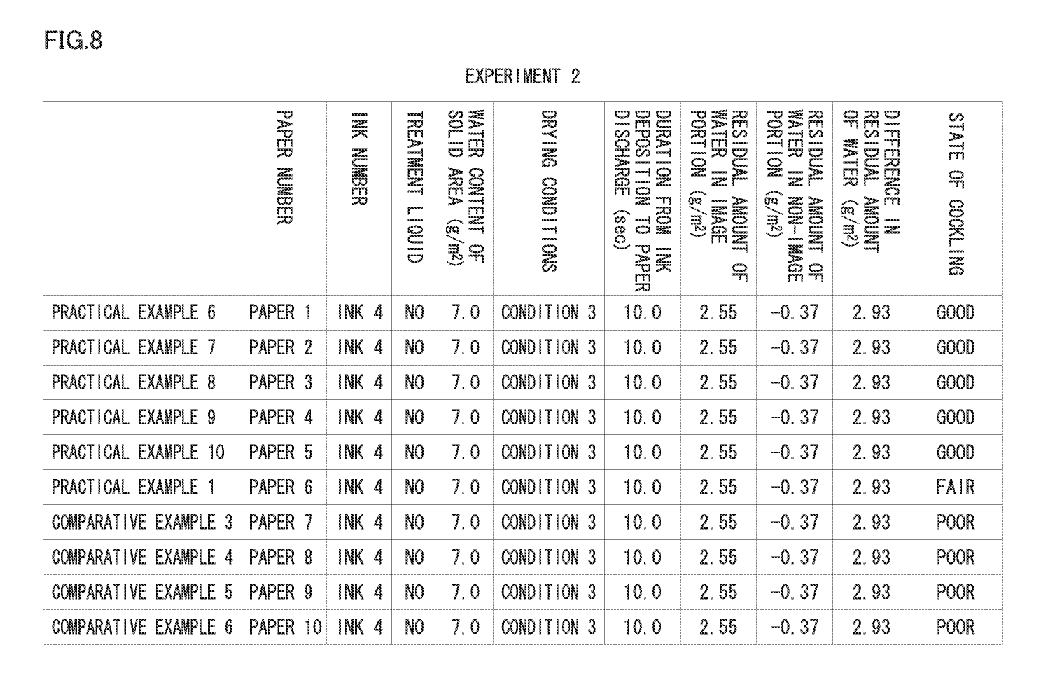

As shown in FIG. 8, in Experiment 2 where the recording media were changed, cockling could be suppressed in each of Practical Examples 1 and 6 to 10, which used the recording medium having the rate of expansion and contraction of not more than 0.10% when water was applied at 1 g/m², but cockling could not be suppressed in each of Comparative Examples 3 to 6, which used the recording medium having the rate of expansion and contraction exceeding 0.10%.

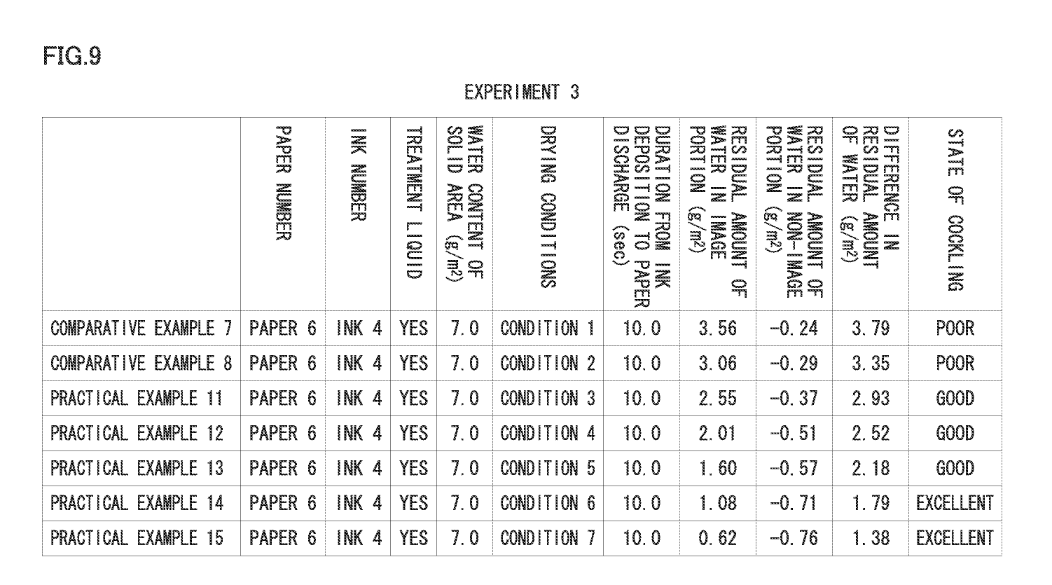

As shown in FIG. 9, in Experiment 3 where the treatment liquid was deposited onto the recording medium, similarly to Experiment 1 where no treatment liquid was deposited onto the recording medium, it was possible to suppress cockling in each of Practical Examples 11 to 15, where the difference in the residual amount of water was not more than 3.0 g/m², but it was not possible to suppress cockling in each of Comparative Examples 7 and 8, where the difference in the residual amount of water exceeded 3.0 g/m².

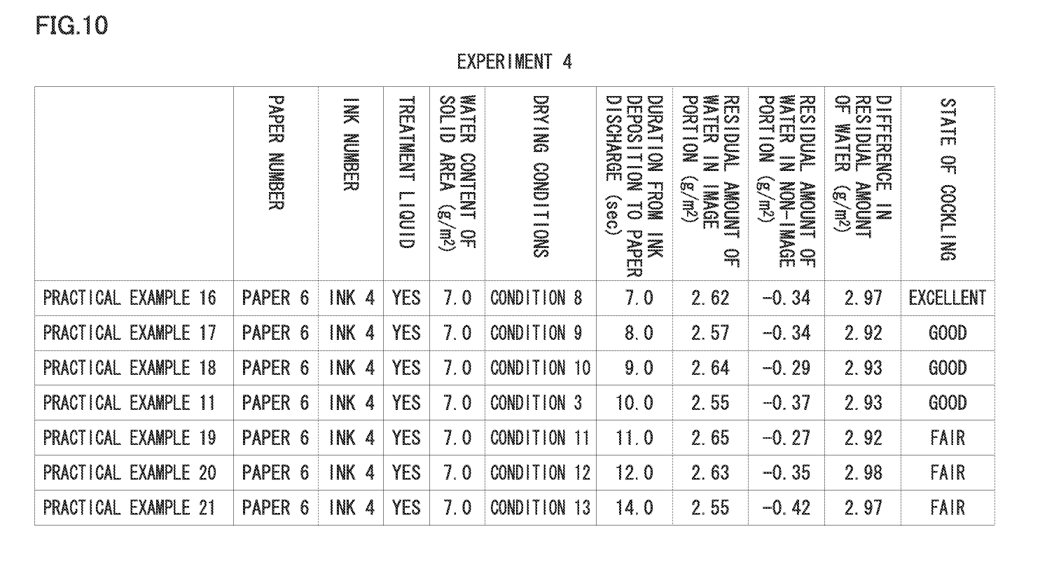

As shown in FIG. 10, in Experiment 4 where the duration from the image forming step until the fixing step was changed, the shorter the duration, the more effectively carrying out drying before the solvent in the ink permeated into the recording medium, and hence the greater the ability to suppress cockling in Practical Examples 16 to 21. In Experiment 4, adjustment was made by altering the temperature of the pressure drum in such a manner that the difference in the residual amount of water after the drying step was equal.

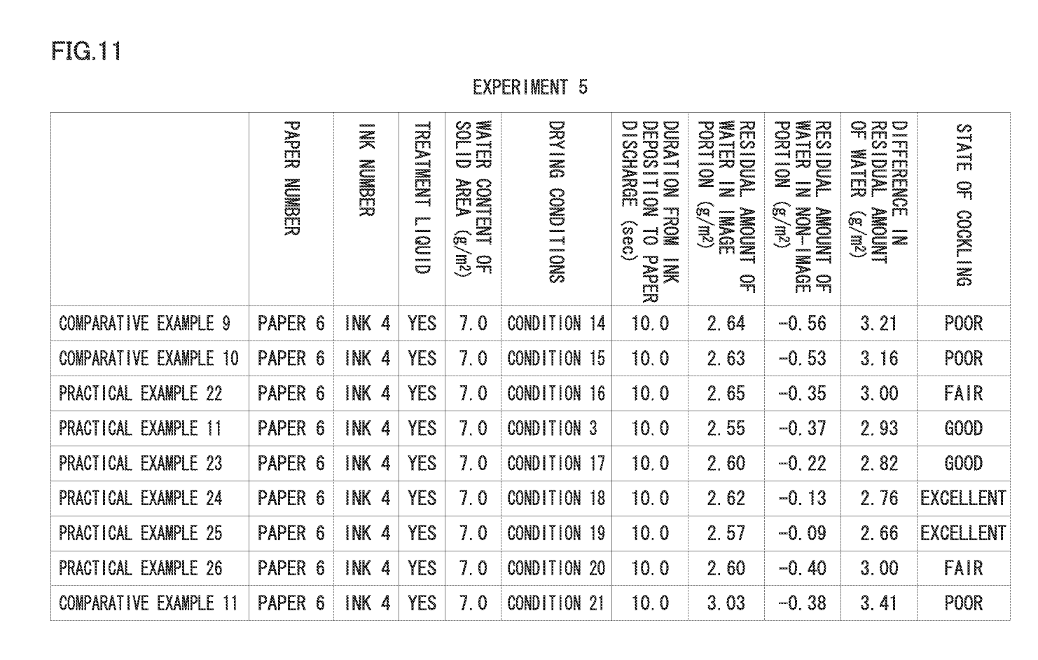

As shown in FIG. 11, in Experiment 5 where the relative humidity of the drying air flow was changed, drying of the non-image portion progressed simultaneously with the drying of the image portion in Comparative Examples 9 and 10 where the relative humidity at 23° C. of the drying air flow was low, and hence it was not possible to restrict the difference in the residual amount of water and this value exceeded 3.0 g/m². Conversely, in Comparative Example 11 where the relative humidity was a high value of 95% RH, the drying of the image portion did not progress and therefore it was not possible to reduce the difference in the residual amount of water, the difference in the residual amount of water then exceeded 3.0 g/m² and cockling occurred. On the other hand, it was possible to suppress cockling in each of Practical Examples 11 and 22 to 26.

As shown in FIG. 12, in Experiment 6 where the SP value of the water-soluble organic solvent was changed, it was possible to suppress cockling in Practical Examples 11 and 27 to 32, which used any water-soluble organic solvent, and it was possible to suppress cockling further by using the solvent having the lower SP value.

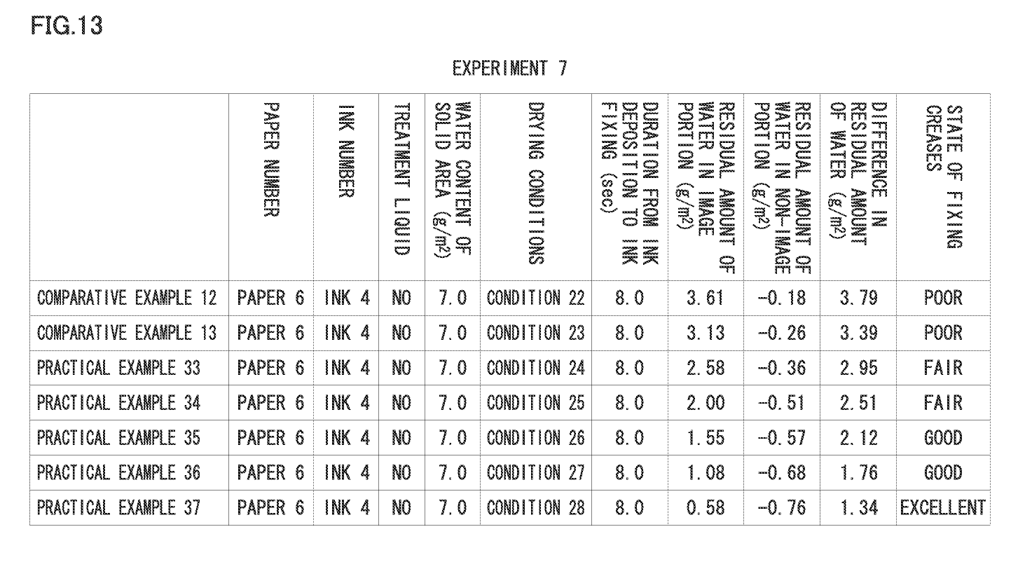

On the other hand, fixing creases were evaluated while changing the residual amount of water (Experiment 7), the recording medium (Experiment 8), the presence/absence of treatment liquid (Experiment 9), the time from image formation until fixing (Experiment 10), the relative humidity of the drying air flow (Experiment 11), or the SP value of the water-soluble organic solvent (Experiment 12). The results are shown in FIGS. 13 to 18, respectively.

As shown in FIG. 13, in Experiment 7 where the residual amount of water was changed, it was possible to form an image in which fixing creases on the recording medium were suppressed by setting the difference in the residual amount of water between the image portion and the non-image portion to be not more than 3.0 g/m² in each of Practical Examples 33 to 37. Furthermore, as the difference in the residual amount of water decreased, it became more possible to suppress cockling. This is because cockling can be suppressed by reducing the difference in the residual amount of water between the image portion and the non-image portion, and it is thereby possible to obtain a flat recording medium with few projecting sections at the fixing stage. Thus, it is possible to form an image without the occurrence of creases due to squashing the projecting sections by the heat roller. Conversely, in Comparative Examples 12 and 13 where the difference in the residual amount of water exceeded 3.0 g/m², cockling occurred and fixing creases could not be suppressed.

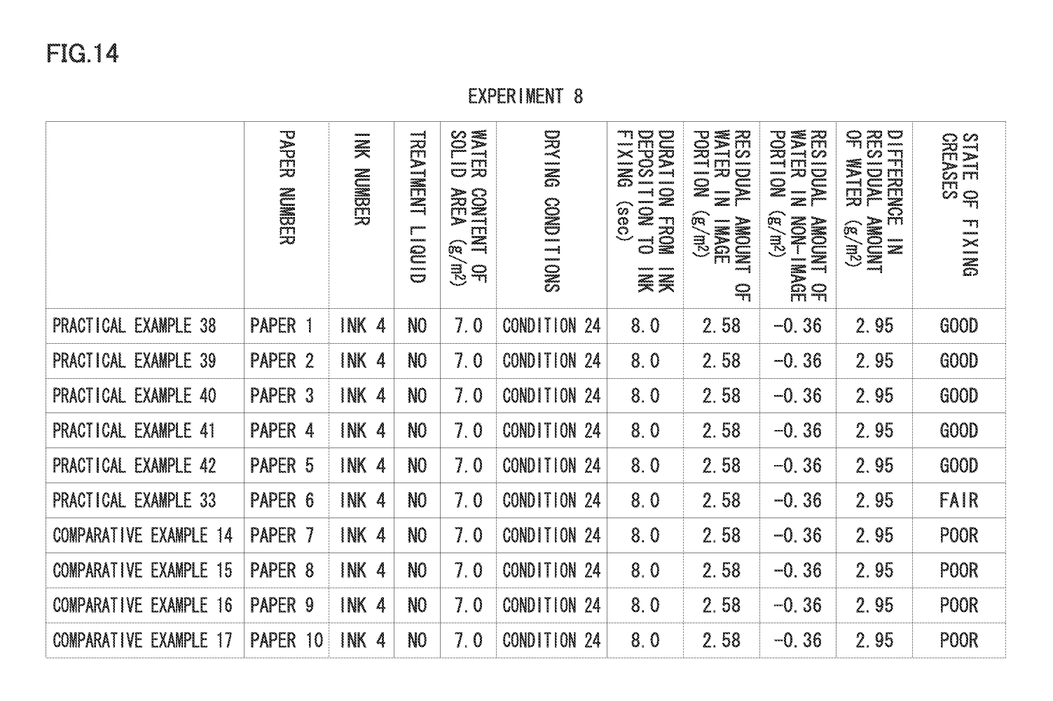

As shown in FIG. 14, in Experiment 8 where the recording media were changed, fixing creases could be suppressed in each of Practical Examples 33 and 38 to 42, which used the recording medium having the rate of expansion and contraction of not more than 0.10% when water was applied at 1 g/m², but fixing creases could not be suppressed in each of Comparative Examples 14 to 17, which used the recording medium having the rate of expansion and contraction exceeding 0.10%.

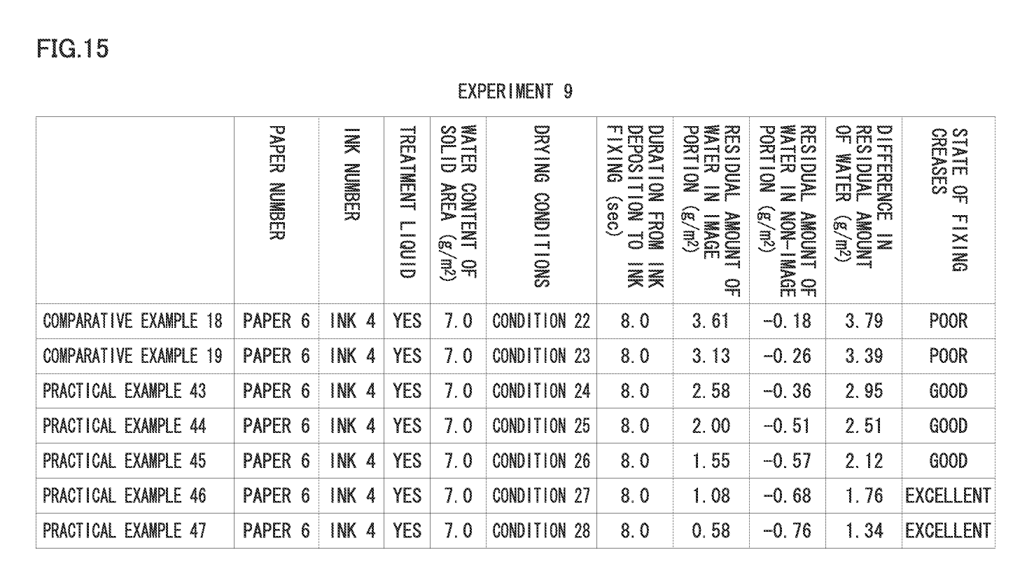

As shown in FIG. 15, in Experiment 9 where the treatment liquid was deposited onto the recording medium, similarly to Experiment 7 where no treatment liquid was deposited onto the recording medium, it was possible to suppress fixing creases in each of Practical Examples 43 to 47, where the difference in the residual amount of water was not more than 3.0 g/m², but it was not possible to suppress fixing creases in each of Comparative Examples 18 and 19, where the difference in the residual amount of water exceeded 3.0 g/m².

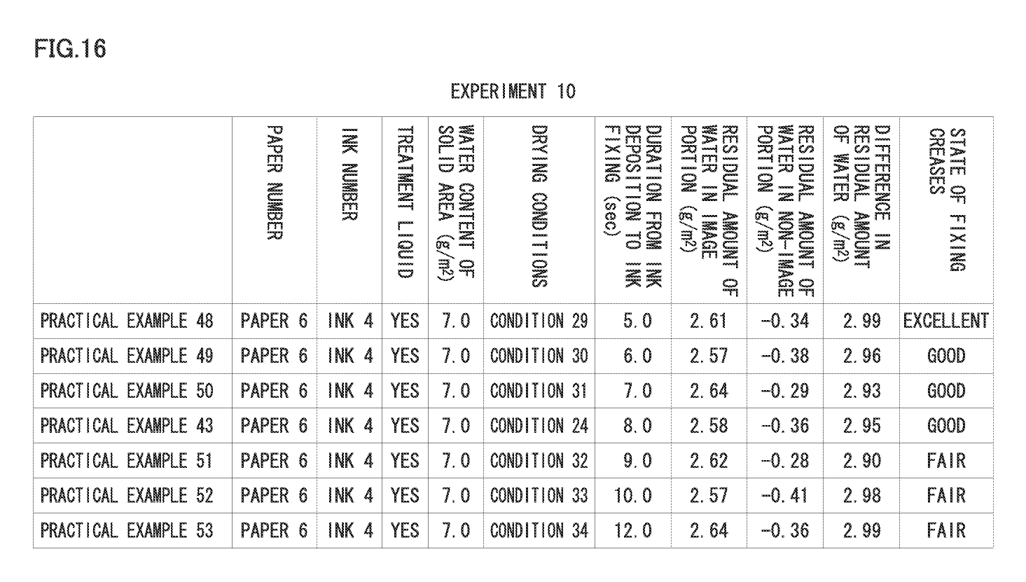

As shown in FIG. 16, in Experiment 10 where the duration from the image forming step until the fixing step was changed, the shorter the duration, the more effectively carrying out drying before the solvent in the ink permeated into the recording medium, and hence the greater the ability to suppress cockling and then suppress fixing creases in Practical Examples 48 to 53. In Experiment 4, adjustment was made by altering the temperature of the pressure drum in such a manner that the difference in the residual amount of water after the drying step was equal.

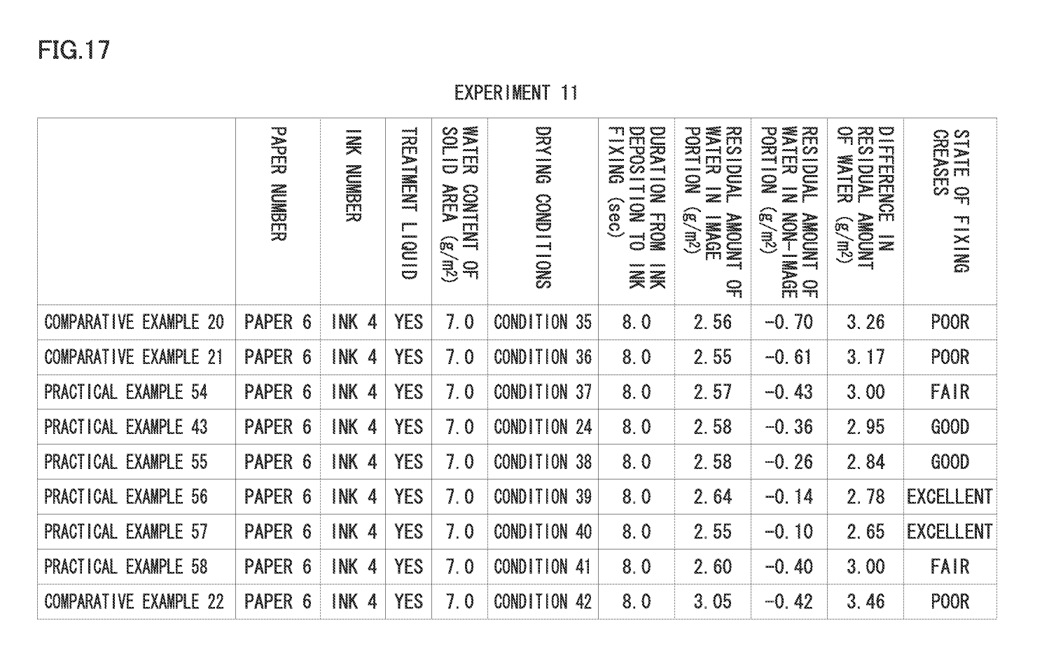

As shown in FIG. 17, in Experiment 11 where the relative humidity of the drying air flow was changed, drying of the non-image portion progressed simultaneously with the drying of the image portion in Comparative Examples 20 and 21 where the relative humidity at 23° C. of the drying air flow was low, and hence it was not possible to restrict the difference in the residual amount of water and this value exceeded 3.0 g/m² and fixing creases occurred. Conversely, in Comparative Example 22 where the relative humidity was a high value of 95% RH, the drying of the image portion did not progress and therefore it was not possible to reduce the difference in the residual amount of water, the difference in the residual amount of water then exceeded 3.0 g/m² and fixing creases occurred. On the other hand, it was possible to suppress and fixing creases occurred in each of Practical Examples 43 and 54 to 58.

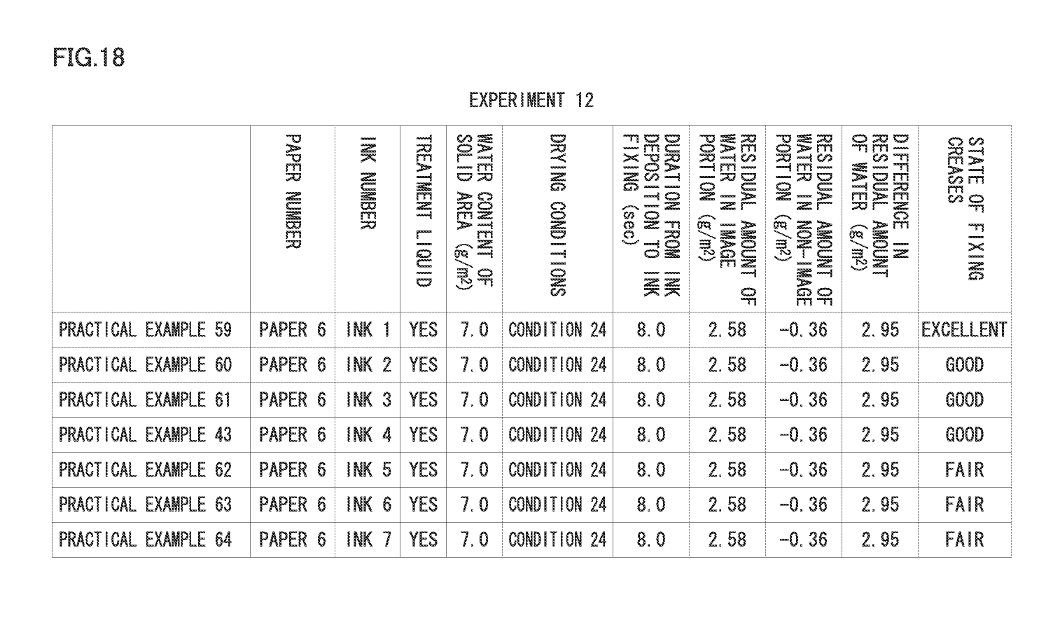

As shown in FIG. 18, in Experiment 12 where the SP value of the water-soluble organic solvent was changed, it was possible to suppress fixing creases in Practical Examples 43 and 59 to 64, which used any water-soluble organic solvent, and it was possible to suppress fixing creases further by using the solvent having the lower SP value.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming method, comprising:
an image forming step of forming an image on a recording medium by using aqueous ink, the recording medium showing dimensional change of not more than 0.1% with respect to water content of 1 g/m²;
a drying step of drying the ink on the recording medium after the image forming step; and
a recording medium discharge step of discharging the recording medium after the drying step,
wherein the drying is carried out in the drying step so that a difference in water content between an image portion and a non-image portion of the recording medium immediately before the recording medium discharge step is not more than 3.0 g/m².

2. The image forming method as defined in claim 1, further comprising:
after the drying step and before the recording medium discharge step, a fixing step of fixing the ink on the recording medium by applying pressure thereto,
wherein the drying is carried out in the drying step so that a difference in water content between the image portion and the non-image portion of the recording medium immediately before the fixing step is not more than 3.0 g/m².

3. The image forming method as defined in claim 2, wherein duration from the image forming step until start of the fixing step is not longer than 8 seconds.

4. The image forming method as defined in claim 1, wherein the image forming step includes ejecting and depositing droplets of the ink onto the recording medium by a single-pass inkjet method using a line head having a width corresponding to a width of the recording medium.

5. The image forming method as defined in claim 1, wherein an amount of the ink deposited onto the recording medium in the image forming step causes the water content per unit surface area of the recording medium to become not less than 7.0 g/m².

6. The image forming method as defined in claim 1, further comprising, before the image forming step, a treatment liquid deposition step of depositing a treatment liquid onto the recording medium, the treatment liquid containing a component which reacts with pigment and resin particles contained in the ink.

7. The image forming method as defined in claim 1, wherein duration from the image forming step until the recording medium discharge step is not longer than 10 seconds.

8. The image forming method as defined in claim 1, wherein the drying step is carried out by supplying a drying air flow to the recording medium, the drying air flow having a relative humidity at 23° C. of not less than 40%.

9. The image forming method as defined in claim 8, wherein the drying air flow has a relative humidity at 23° C. of not more than 90%.

10. The image forming method as defined in claim 8, wherein temperature of the drying air flow is not lower than 50° C.

11. The image forming method as defined in claim 1, wherein the ink contains a water-soluble organic solvent having an SP value of not more than 27.2 (MPa)^{1/2}.

12. An image forming apparatus, comprising:
an image forming device which forms an image on a recording medium by using aqueous ink, the recording medium showing dimensional change of not more than 0.1% with respect to water content of 1 g/m²;
a drying device which dries the ink on the recording medium on which the image has been formed by the image forming device;
a recording medium discharge device which discharges the recording medium which has been dried by the drying device; and
a control device which controls the drying device so that a difference in water content between an image portion and a non-image portion of the recording medium when discharged by the recording medium discharge device is not more than 3.0 g/m².

13. The image forming apparatus as defined in claim 12, further comprising:
a fixing device which fixes the ink on the recording medium by applying pressure to the recording medium after being dried by the drying device and before being discharged by the recording medium discharge device,
wherein the control device controls the drying device so that a difference in water content between the image portion and the non-image portion of the recording medium when the fixing device carries out fixing is not more than 3.0 g/m².

14. The image forming apparatus as defined in claim 13, wherein duration from forming of the image by the image forming device until start of the fixing by the fixing device is not longer than 8 seconds.

15. The image forming apparatus as defined in claim 12, wherein the image forming device includes a line head having a width corresponding to a width of the recording medium, and forms the image by ejecting and depositing droplets of the ink onto the recording medium by a single-pass inkjet using the line head.

16. The image forming apparatus as defined in claim 12, wherein the image forming device deposits an amount of the ink onto the recording medium to cause the water content per unit surface area of the recording medium to become not less than 7.0 g/m².

17. The image forming apparatus as defined in claim 12, further comprising a treatment liquid deposition device which deposits a treatment liquid onto the recording medium on which the image has not been formed by the image forming device, the treatment liquid containing a component which reacts with pigment and resin particles contained in the ink.

18. The image forming apparatus as defined in claim 12, wherein duration from forming of the image by the image forming device until discharging of the recording medium by the recording medium discharge device is not longer than 10 seconds.

19. The image forming apparatus as defined in claim 12, wherein the drying device dries the ink by supplying a drying air flow to the recording medium, the drying air flow having a relative humidity at 23° C. of not less than 40%.

20. The image forming apparatus as defined in claim 19, wherein the drying air flow has a relative humidity at 23° C. of not more than 90%.

21. The image forming apparatus as defined in claim 19, wherein temperature of the drying air flow is not lower than 50° C.

22. The image forming apparatus as defined in claim 12, wherein the ink contains a water-soluble organic solvent having an SP value of not more than 27.2 (MPa)^{1/2}.
